(19) United States
(12) Patent Application Publication
(10) Pub. No.: US 2017/0121573 A1
(43) Pub. Date: May 4, 2017

(54) SHOCK ABSORBING EXPANDED ADHESIVE AND ARTICLES THEREFROM

(71) Applicant: Avery Dennison Corporation, Glendale, CA (US)

(72) Inventors: Josh M. BOGNER, Euclid, OH (US); Henry W. MILLIMAN, Willoughby, OH (US)

(73) Assignee: Avery Dennison Corporation, Glendale, CA (US)

(21) Appl. No.: 15/124,880

(22) PCT Filed: Mar. 13, 2015
(86) PCT No.: PCT/US15/20424

§ 371 Date: Sep. 9, 2016

Related U.S. Application Data
(60) Provisional application No. 61/952,209, filed on Mar. 13, 2014.

(51) Int. Cl. C09J 11/08; C09J 7/02

(52) U.S. Cl. CPC C09J 11/08; C09J 7/02; C09J 2205/11; C09J 2421/00; C09J 2433/00

(57) ABSTRACT

Adhesive formulations comprising expandable microspheres are described. After forming into a layer or region and expanding, the expanded adhesive layer exhibits excellent impact absorbing characteristics. The expanded adhesive layer also exhibits excellent vibration damping properties.

### CROSS-REFERENCE TO RELATED APPLICATION

The present application claims the benefit of U.S. Provisional Application No. 61/952,209 filed Mar. 13, 2014, which is incorporated herein by reference in its entirety.

### FIELD

The present subject matter relates to expanded adhesive compositions, products using such adhesives such as tape strips, and related methods of use.

### BACKGROUND

Expanded adhesives such as foamed adhesives are known in the art. Foamed adhesives are known to exhibit vibration damping and/or shock absorbing properties. Foamed adhesives have been used for adhesively bonding electronic components.

However, as a result of foaming or expansion, layers formed from such adhesives are relatively thick. Thick adhesive layers are undesirable for certain applications such as bonding components in thin electronic devices, for example tablet computers and smartphones. Accordingly, a need remains for an adhesive formulation that exhibits vibration damping and/or shock absorbing properties yet can be used in relatively thin layers.

### SUMMARY

The difficulties and drawbacks associated with previously known foamed adhesives and tape strip products are addressed in the present subject matter.

In one aspect, the present subject matter provides an adhesive formulation comprising 50 to 99% of one or more adhesive components, 0 to 3% crosslinker, 0 to 3% antioxidant, and 0.1 to 10% expandable microspheres dispersed throughout the formulation.

In another aspect, the present subject matter provides a layered adhesive assembly comprising a film, and a layer of adhesive disposed on the film. The adhesive includes 50 to 99% of at least one adhesive component, 0 to 3% crosslinker, 0 to 3% antioxidant, and 0.1 to 10% expandable microspheres dispersed throughout the formulation.

In another aspect, the present subject matter provides a layered adhesive assembly comprising a core adhesive layer and two, first and second, skin layers. The core adhesive layer includes 50 to 99% of at least one adhesive component, 0 to 5% crosslinker, 0 to 3% antioxidant, and 0.1 to 10% expandable microspheres dispersed throughout the formulation.

In still another aspect, the present subject matter provides a method of absorbing mechanical shocks to a component affixed to a substrate. The method comprises providing a layer of adhesive including 50 to 99% of one or more adhesive components, 0 to 3% crosslinker, 0 to 3% antioxidant, and 0.1 to 10% expandable microspheres dispersed throughout the formulation. The method also comprises disposing the layer of the adhesive between the component and the substrate.

In still another aspect, the present subject matter provides a method of mechanical shocks to a component affixed to a substrate. The method comprises providing a layered assembly comprising a core adhesive layer and two skin layers. The core adhesive layer includes 50 to 99% of at least one adhesive component, 0 to 5% crosslinker, 0 to 3% antioxidant, and 0.1 to 10% expandable microspheres dispersed throughout the formulation. The first and second skin layers attach to each face of the core adhesive layer. The first skin layer would also attach to the component and the second skin layer would also attach to the substrate.

As will be realized, the subject matter described herein is capable of other and different embodiments and its several details are capable of modifications in various respects, all without departing from the claimed subject matter. Accordingly, the drawings and description are to be regarded as illustrative and not restrictive.

### BRIEF DESCRIPTION OF THE DRAWINGS

FIG. 1 is a schematic cross sectional view of an embodiment of layered assemblies in accordance with the present subject matter prior to expansion, and after expansion.

FIG. 2 is a schematic cross sectional view of an embodiment of a bonded assembly in accordance with the present subject matter.

FIG. 3 is a schematic cross sectional view of an embodiment of another layered assembly in accordance with the present subject matter.

FIG. 4 is a schematic cross sectional view of an embodiment of another layered assembly in accordance with the present subject matter.

FIG. 5 is a schematic cross sectional view of an embodiment of another layered assembly in accordance with the present subject matter.

FIG. 6 is a schematic cross sectional view of an embodiment of another bonded assembly in accordance with the present subject matter.

FIG. 7 is a graph of thickness and density of a layer of expanded adhesive as a function of microsphere loading.

FIG. 8 is a graph of adhesion strength of expanded adhesive as a function of microsphere loading.

FIG. 9 is a graph of adhesion strength of expanded adhesive as a function of microsphere loading.

FIG. 10 is a graph of loop tack strength of expanded adhesive as a function of microsphere loading.

### DETAILED DESCRIPTION OF THE EMBODIMENTS

The present subject matter relates to adhesive formulations that comprise microspheres, and in particular expandable microspheres. The formulations can be coated onto a film or other substrate. After depositing the adhesive onto the film and forming a layer or region of the adhesive on the film, one or more other films, substrates, or release liners can optionally be applied onto the deposited adhesive. In many embodiments of the present subject matter, the adhesive formulation is then expanded or otherwise subjected to conditions to cause expansion of at least a portion of the microspheres within the adhesive formulation. The resulting expanded adhesive assembly can be used for adhesively mounting various components such as electronic components. The present subject matter also provides various assemblies comprising the adhesive formulations. For example, in various embodiments, layered assemblies including one or more polymeric substrates and the adhesive formulation are provided in the form of tape strips. Furthermore, the present subject matter also provides various methods of use involving the adhesive formulations and the layered assemblies including the adhesive formulations. The present subject matter will now be described in greater detail as follows.

### Adhesive Formulations

The present subject matter provides various adhesive formulations that can comprise an effective amount of expandable microspheres dispersed within an adhesive matrix. The present subject matter also provides additional adhesive layers without expanding microspheres. Table 1 set forth below summarizes various embodiments of the present subject matter adhesive formulations. All percentages noted herein are percentages by weight unless noted otherwise.

TABLE 1
Adhesive Formulations containing microspheres

| Component | Typical | Particular |
|---|---|---|
| Adhesive | 50-99% | 65-75% |
| Tackifier | 0-40% | 25-35% |
| Crosslinker | 0-3% | 0.1-1% |
| Antioxidant | 0-3% | 0.25-1% |
| Microspheres | 0.1-10% | 1.5-4% |

In some embodiments at least one additional adhesive layer is present. In one embodiment, there are two additional skin adhesive layers. Table 2 sets forth a summary of various embodiments of additional adhesive layers of the present subject matter. All percentages noted herein are percentages by weight unless noted otherwise.

TABLE 2
Additional Adhesive Formulation

| Component | Typical | Particular |
|---|---|---|
| Adhesive | 40-99% | 50-99% |
| Tackifier | 0-40% | 20-40% |
| Crosslinker | 0-5% | 0.1-5% |
| Antioxidant | 0-5% | 0-3% |

A wide array of adhesives and/or adhesive types can be used as the adhesive component for any adhesive layer. The adhesive component may be selected from any of a variety of materials, such as acrylics, polyurethanes, thermoplastic elastomers, block copolymers, polyolefins, silicones, rubber based adhesives, and blends of two or more of the foregoing. In many embodiments, the adhesive component is an acrylate adhesive. Nonlimiting examples of monomers and oligomers for inclusion in the acrylate adhesive component are described herein. In many embodiments, the adhesive component is a pressure sensitive adhesive (PSA). A description of useful pressure sensitive adhesive may be found in Encyclopedia of Polymer Science and Engineering, Vol. 13, Wiley-Interscience Publishers (New York, 1988). Additional description of useful PSAs may be found in Encyclopedia of Polymer Science and Technology, Vol. 1, Interscience Publishers (New York, 1964).

A particular acrylate adhesive for use as the adhesive component in the adhesive formulations of the present subject matter is set forth below in Table 3.

TABLE 3
Acrylate Adhesive Component

| Component | Typical |
|---|---|
| Acrylic Acid | 0.1-5% |
| Crosslinker | 0.1-3% |
| Butyl Acrylate | 2-15% |
| 2-Ethyl Hexyl Acrylate (2-EHA) | 30-40% |
| Ethyl Acetate | 20-50% |
| 2,4 Pentanedione | 0.1-5% |
| Toluene | 10-45% |
| Antioxidant | 0.1-1% |
| Vinyl Acetate | 0.1-5% |
| Initiator | 0.01-1% |
| TOTAL | 100% |

In certain embodiments, the acrylic polymers for the pressure sensitive adhesive layer(s) include those formed from polymerization of at least one alkyl acrylate monomer containing from about 4 to about 12 carbon atoms in the alkyl group, and present in an amount from about 35-95% by weight of the polymer or copolymer, as disclosed in U.S. Pat. No. 5,264,532. Optionally, the acrylic based pressure sensitive adhesive might be formed from a single polymeric species.

In one embodiment, the pressure sensitive adhesive comprises an acrylic adhesive such as those that are homopolymers, copolymers or cross-linked copolymers of at least one acrylic or methacrylic component. Examples include acrylic esters such as methyl acrylate, ethyl acrylate, n-propyl acrylate, isopropyl acrylate, n-butyl acrylate, isobutyl acrylate, tert-butyl acrylate, amyl acrylate, hexyl acrylate, octyl acrylate, 2-ethylhexyl acrylate, undecyl acrylate or lauryl acrylate, and optionally as a comonomer, a carboxyl-containing monomer such as (meth)acrylic acid [the expression “(meth)acrylic” acid denotes acrylic acid and methacrylic acid], itaconic acid, crotonic acid, maleic acid, maleic anhydride or butyl maleate, a hydroxyl-containing monomer such as 2-hydroxyethyl(meth)acrylate, 2-hydroxypropyl(meth)acrylate or allyl alcohol, an amido-containing monomer such as (meth)acrylamide, N-methyl(meth)acrylamide, or N-ethyl-(meth)acrylamide, a methylol group-containing monomer such as N-methylol(meth)acrylamide or dimethylol(meth)acrylamide, an amino-containing monomer such as aminoethyl(meth)acrylate, dimethylaminoethyl(meth)acrylate or vinylpyridine, or a non-functional monomer such as ethylene, propylene, styrene or vinyl acetate; mixtures thereof, and adhesives containing at least one such adhesive as a main component.

The present subject matter also includes the use of other adhesives such as rubber or rubber-based adhesives. Specifically and in certain embodiments, the pressure sensitive adhesive utilized in the present subject matter comprises rubber based elastomer materials containing linear, branched, grafted, or radial block copolymers represented by the diblock structure A-B, the triblock A-B-A, the radial or coupled structures (A-B)n, and combinations of these where A represents a hard thermoplastic phase or block which is non-rubbery or glassy or crystalline at room temperature but fluid at higher temperatures, and B represents a soft block which is rubbery or elastomeric at service or room temperature. These thermoplastic elastomers may comprise from about 75% to about 95% by weight of rubbery segments and from about 5% to about 25% by weight of non-rubbery segments.

The non-rubbery segments or hard blocks comprise polymers of mono- and polycyclic aromatic hydrocarbons, and more particularly vinyl-substituted aromatic hydrocarbons that may be monocyclic or bicyclic in nature. The rubbery blocks or segments are polymer blocks of homopolymers or copolymers of aliphatic conjugated dienes. Rubbery materials such as polyisoprene, polybutadiene, and styrene butadiene rubbers may be used to form the rubbery block or segment. Rubbery segments include polydienes and saturated olefin rubbers of ethylene/butylene or ethylene/propylene copolymers. The latter rubbers may be obtained from the corresponding unsaturated polyalkylene moieties such as polybutadiene and polyisoprene by hydrogenation thereof.

The block copolymers of vinyl aromatic hydrocarbons and conjugated dienes that may be utilized include any of those which exhibit elastomeric properties. The block copolymers may be diblock, triblock, multiblock, starblock, polyblock or graftblock copolymers.

Such block copolymers may contain various ratios of conjugated dienes to vinyl aromatic hydrocarbons including those containing up to about 40% by weight of vinyl aromatic hydrocarbon. Accordingly, multi-block copolymers may be utilized which are linear or radial symmetric or asymmetric and which have structures represented by the formulae A-B, A-B-A, A-B-A-B, B-A-B, (AB)O, 1, 2 . . . BA, etc., wherein A is a polymer block of a vinyl aromatic hydrocarbon or a conjugated diene/vinyl aromatic hydrocarbon tapered copolymer block, and B is a rubbery polymer block of a conjugated diene. Specific examples of diblock copolymers include styrene-butadiene (SB), styrene-isoprene (SI), and the hydrogenated derivatives thereof. Examples of triblock polymers include styrene-butadiene-styrene (SBS), styrene-isoprene-styrene (SIS), alpha-methylstyrene-butadiene-alpha-methylstyrene, and alpha-methylstyrene-isoprene alpha-methylstyrene. Examples of commercially available block copolymers useful as the adhesive component(s) in the present subject matter include those available from Kraton Polymers LLC under the KRATON trade name.

Many embodiments of the present adhesive formulations comprise one or more tackifiers. Nonlimiting examples of tackifiers include FORAL 85 Resin, available from Pinova. Tackifiers are generally hydrocarbon resins, wood resins, rosins, rosin derivatives, and the like. It is contemplated that any tackifier known by those of skill in the art to be compatible with adhesive formulations may be used with the present subject matter. One such tackifier, found useful is WINGTAK 10, a synthetic polyterpene resin that is liquid at room temperature, and sold by the Goodyear Tire and Rubber Company of Akron, Ohio. WINGTAK 95 is a synthetic tackifier resin also available from Goodyear that comprises predominantly a polymer derived from piperylene and isoprene. Other suitable tackifying additives may include ESCOREZ 1310, an aliphatic hydrocarbon resin, and ESCOREZ 2596, a C₅-C₈ (aromatic modifier aliphatic) resin, both manufactured by Exxon of Irving, Tex.

In many embodiments of the present subject matter, the adhesive component is curable and thus able to undergo crosslinking as known in the art. For such embodiments, the adhesive formulation typically comprises one or more crosslinkers or crosslinking agents. The crosslinker(s) are typically selected based upon the adhesive component. An example of a typical crosslinker for acrylate adhesives is aluminum acetyl acetonate (AAA).

The adhesive formulations may also comprise one or more antioxidants. Nonlimiting examples of such antioxidants include ULTRANOX 626 commercially available from various suppliers.

The present adhesive formulations also comprise microspheres and particularly expandable microspheres. In many embodiments, the microspheres are small spherical polymeric particles. The microspheres can include a thermoplastic polymeric shell encapsulating a gas filled hollow interior core. Upon heating the microspheres, internal pressure from the gas increases and the thermoplastic shell softens. This results in a significant increase in volume of the microspheres. In many embodiments of the present subject matter, the expanded microspheres do not rupture upon heating and thus contain the gas in their core. Nonlimiting examples of typical sizes of microspheres prior to expansion are within a range of from about 5 μm to about 75 μm, in certain embodiments from 8 μm to 20 μm, and more particularly from 6 μm to 9 μm or 10 μm to 16 μm. In another embodiment, the range could be 20 μm to 40 μm. All particle sizes and dimensions noted herein are with respect to a median value of a population or sample of interest, i.e., D(0.5) as known in the art.

The expandable microspheres can be selected so as to expand upon exposure to particular temperatures or ranges of temperatures. For many embodiments of the present subject matter, the microspheres expand upon exposure to temperatures in a range of from about 70° C. to about 220° C., more particularly from 75° C. to 100° C., and in particular embodiments within a temperature range of 80° C. to 95° C. or 100° C. to 106° C. The expandable microspheres typically also exhibit a maximum temperature at which the microspheres do not rupture. Nonlimiting examples of such maximum nonrupture temperatures include from about 120° C. to about 210° C., and particularly from 120° C. to 135° C. or 137° C. to 145° C.

In addition to or instead of heating, the present subject matter also includes microsphere expansion techniques involving exposure to pressure reductions. For example, microspheres can be expanded by subjecting the microspheres to pressures of less than 1 atmosphere. However, for many embodiments of the present subject matter, microsphere expansion is performed exclusively by heating.

After expansion of the microspheres, the size of the expanded microspheres typically is within a size range of from about 10 μm to about 200 μm, more particularly from 20 μm to 150 μm, and in certain embodiments from 25 μm to 100 μm. However, it will be appreciated that the present subject matter includes expanded microspheres having sizes less than and/or greater than these sizes.

The microspheres, although termed “spheres,” need not be spherical. That is, the present subject matter includes the use of nonspherical particles such as particles which are oblong, ovoid, or irregular in shape.

As previously noted, in many embodiments of the present subject matter upon expansion of the microspheres, at least a portion and in many embodiments a majority of the expanded microspheres are intact and not ruptured. However, the present subject matter also includes microspheres that are ruptured.

The microspheres include a thermoplastic polymeric shell. In many embodiments, the polymeric shell includes acrylonitrile. Microspheres are readily available in a range of particle sizes for use in adhesive formulations.

The adhesive formulations in many embodiments may optionally also comprise one or more liquid vehicles or solvents. The liquid vehicle(s) is typically an organic vehicle, however the present subject matter includes aqueous agents such as water and alcohols. A nonlimiting example of an organic vehicle is toluene. However, it will be appreciated that the present subject matter includes the use of other vehicles and/or solvents in addition to, or instead of, toluene. The liquid vehicle or solvent is typically used as a processing aid. For example, selective addition of the vehicle to the adhesive formulation is used to adjust the viscosity of the adhesive formulation such as prior to depositing the formulation onto a film or carrier of interest as described herein. A nonlimiting example of a weight ratio of liquid vehicle such as toluene that is combined with the adhesive formulation is 60/40 to 5/95, and more particularly 50/50 to 10/90, of liquid vehicle to adhesive formulation, respectively. Additional details and aspects of components of the adhesive formulation are described herein.

The adhesive formulations typically also comprise one or more polymerization initiators. The selection of the initiator(s) is typically based upon the components of the formulation. A nonlimiting example of a suitable initiator is 2,2′-azobis (2-methylbutyronitrile). This initiator is commercially available from several suppliers under the designation VAZO 67.

The adhesive formulations may also comprise additional agents such as pigments and specifically, carbon black for example.

The adhesive may also comprise one or more fillers. Combinations of fillers/pigments may be used. The filler includes carbon black, calcium carbonate, titanium dioxide, clay, diatomaceous earth, talc, mica, barium sulfate, aluminum sulfate, silica, or mixtures of two of more thereof. A wide array of organic fillers could be used.

In another embodiment, a useful filler combination includes an anti-blocking agent, which is chosen depending on the processing and/or use conditions. Examples of such agents include for example silica, talc, diatomaceous earth, and any mixtures thereof. The filler particles may be finely divided substantially water-insoluble inorganic filler particles.

The finely divided substantially water-insoluble inorganic filler particles can include particles of metal oxides. The metal oxide constituting the particles may be a simple metal oxide (i.e., the oxide of a single metal) or it may be a complex metal oxide (i.e., the oxide of two or more metals). The particles of metal oxide may be particles of a single metal oxide or they may be a mixture of different particles of different metal oxides.

Examples of suitable metal oxides include alumina, silica, and titania. Other oxides may optionally be present in minor amount. Examples of such optional oxides include, but are not limited to, zirconia, hafnia, and yttria. Other metal oxides that may optionally be present are those which are ordinarily present as impurities such as for example, iron oxide. For purposes of the present specification and claims, silicon is considered to be a metal.

When the particles are particles of alumina, most often the alumina is alumina monohydroxide. Particles of alumina monohydroxide, AIO(OH), and their preparation are known.

The adhesive can comprise additional components such as, but not limited to, plasticizer oils, flame retardants, UV stabilizers, optical brighteners, and combinations thereof.

The fillers, pigments, plasticizers, flame retardants, UV stabilizers, and the like are optional in many embodiments and can be used at concentrations of from 0 to 30% or more, such as up to 40% in particular embodiments. In certain embodiments, the total amount of fillers (inorganic and/or organic), pigments, plasticizers, flame retardants, UV stabilizers, and combinations thereof is from 0.1% to 30%, and more particularly from 1% to 20%.

The microspheres, agents, and components of the adhesive formulation are combined in any suitable fashion such as by conventional blending techniques. The microspheres are typically dispersed within the adhesive formulation and in most embodiments are uniformly dispersed or substantially so, throughout the adhesive formulation by mixing or blending. As previously noted one or more liquid vehicles can be incorporated into the formulation such as for example to promote dispersal of the microspheres and/or to adjust the viscosity of the resulting formulation.

### Films, Layers, and Articles

The present subject matter also provides various layered assemblies of the adhesive formulation disposed on one or more films or layers. An example of such a layered assembly is a tape assembly comprising one or more layers of the adhesive formulation disposed on a polymeric film. An additional example of such a layered assembly is a multilayered adhesive assembly. The present subject matter includes a wide array of polymeric films such as but not limited to polyesters such as polyethylene terephthalate (PET), polystyrenes, polyolefins, polyamides, polycarbonates, polyvinyl alcohol, poly(ethylene vinyl alcohol), polyurethanes, polyacrylates, poly(vinyl acetates), ionomers and mixtures thereof. In one embodiment, the polymeric film material comprises a polyolefin. The polyolefin film materials generally are characterized as having a melt index or melt flow rate of less than 30, or less than 20, or less than 10, as determined by ASTM Test Method 1238.

The polyolefins that can be utilized as the polymeric film material include polymers and copolymers of ethylene, propylene, 1-butene, etc., or blends of such polymers and copolymers. In one embodiment, the polyolefins comprise polymers and copolymers of ethylene and propylene. In another embodiment, the polyolefins comprise propylene homopolymers, and copolymers such as propylene-ethylene and propylene-1-butene copolymers. Blends of polypropylene and polyethylene, or blends of either or both of them with polypropylene-polyethylene copolymer are also useful.

Various polyethylenes can be utilized as the polymeric film material. Such polyethylenes include low, medium, and high density polyethylenes. An example of a useful low density polyethylene (LDPE) is REXENE 1017 commercially available from Huntsman.

The propylene homopolymers that can be utilized as the polymeric film material in the constructions of the present subject matter, either alone, or in combination with a propylene copolymer as described herein, include a variety of propylene homopolymers such as those having melt flow rates (MFR) from about 0.5 to about 20 as determined by ASTM Test D 1238, condition L. In one embodiment, propylene homopolymers having MFR's of less than 10, or from about 4 to about 10 are particularly useful and provide substrates having improved die-cuttability. Useful propylene homopolymers also may be characterized as having densities in the range of from about 0.88 to about 0.92 g/cm³. A number of useful propylene homopolymers are available commercially from a variety of sources, including: 5A97, available from Union Carbide and having a melt flow of 12.0 g/10 min and a density of 0.90 g/cm³; DX5E66, also available from Union Carbide and having an MFI of 8.8 g/10 min and a density of 0.90 g/cm³; and WRD5-1057 from Union Carbide having an MFI of 3.9 g/10 min and a density of 0.90 g/cm³. Useful commercial propylene homopolymers are also available from Fina and Montel.

Particularly useful polyamide resins include resins available from EMS American Grilon Inc., Sumter, S.C., under the general tradename GRIVORY such as CF6S, CR-9, XE3303 and G-21. GRIVORY G-21 is an amorphous nylon copolymer having a glass transition temperature of 125° C., a melt flow index (DIN 53735) of 90 ml/10 min and an elongation at break (ASTM D638) of 15. GRIVORY CF65 is a nylon 6/12 film grade resin having a melting point of 135° C., a melt flow index of 50 ml/10 min, and an elongation at break in excess of 350%. GRILON CR9 is another nylon 6/12 film grade resin having a melting point of 200° C., a melt flow index of 200 ml/10 min, and an elongation at break at 250%. GRILON XE 3303 is a nylon 6.6/6.10 film grade resin having a melting point of 200° C., a melt flow index of 60 ml/10 min, and an elongation at break of 100%. Other useful polyamide resins include those commercially available from, for example, Union Camp of Wayne, N.J. under the UNI-REZ product line, and dimer-based polyamide resins available from Bostik, Emery, Fuller, Henkel (under the VERSAMID product line). Other suitable polyamides include those produced by condensing dimerized vegetable acids with hexamethylene diamine. Examples of polyamides available from Union Camp include UNI-REZ 2665; Uni-Rez 2620; UNI-REZ 2623; and UNI-REZ 2695.

Polystyrenes can also be utilized as the polymeric film material in the present subject matter and these include homopolymers as well as copolymers of styrene and substituted styrene such as alpha-methyl styrene. Examples of styrene copolymers and terpolymers include: acrylonitrile-butene-styrene (ABS); styrene-acrylonitrile copolymers (SAN); styrene butadiene (SB); styrene-maleic anhydride (SMA); and styrene-methyl methacrylate (SMMA); etc. An example of a useful styrene copolymer is KR-10 from Phillip Petroleum Co. KR-10 is believed to be a copolymer of styrene with 1,3-butadiene.

Polyurethanes also can be utilized as the polymeric film material of the present subject matter, and the polyurethanes may include aliphatic as well as aromatic polyurethanes.

Polyesters prepared from various glycols or polyols and one or more aliphatic or aromatic carboxylic acids also are useful film materials. Polyethylene terephthalate (PET) and PETG (PET modified with cyclohexanedimethanol) are useful film materials that are available from a variety of commercial sources including Eastman. For example, KODAR 6763 is a PETG available from Eastman Chemical. Another useful polyester from DuPont is SELAR PT-8307, which is polyethylene terephthalate.

Acrylate polymers and copolymers and alkylene vinyl acetate resins (e.g., EVA polymers) also are useful as the film material in the present subject matter. Commercial examples of available polymers include ESCORENE UL-7520, a copolymer of ethylene with 19.3% vinyl acetate (Exxon); NUCRELL 699, an ethylene copolymer containing 11% of methacrylic acid (DuPont); etc. Ionomers (polyolefins containing ionic bonding of molecular chains) also are useful. Examples of ionomers include ionomeric ethylene copolymers such as SURLYN 1706 (DuPont) which is believed to contain interchain ionic bonds based on a zinc salt of ethylene methacrylic acid copolymer. SURLYN 1702 from DuPont also is a useful ionomer.

Polycarbonates also are useful, and these are available from the Dow Chemical Co. (CALIBRE) G.E. Plastics (LEXAN) and Bayer (MAKROLON). Most commercial polycarbonates are obtained by the reaction of bisphenol A and carbonyl chloride in an interfacial process. Molecular weights of the typical commercial polycarbonates vary from about 22,000 to about 35,000, and the melt flow rates generally are in the range of from 4 to 22 g/10 min.

The polymeric film may contain inorganic fillers and other organic or inorganic additives to provide desired properties such as appearance properties (opaque or colored films), durability and processing characteristics. Nucleating agents can be added to increase crystallinity and thereby increase stiffness. Examples of useful additives include calcium carbonate, titanium dioxide, metal particles, fibers, flame retardants, antioxidant compounds, heat stabilizers, light stabilizers, ultraviolet light stabilizers, antiblocking agents, processing aids, acid acceptors, etc.

The present subject matter also includes the use of one or more layers of paper or paper-based materials. The subject matter also comprises composite materials such as polyethylene coated paper.

The adhesive formulations are deposited or applied to a substrate, film or layer of interest using nearly any technique or process. Conventional coating techniques can be used in many applications. The adhesive formulations can be applied at coatweights typically within a range of from 10 gsm to 250 gsm per layer, particularly from 10 gsm to 175 gsm, and more particularly from 25 gsm to 125 gsm. In another embodiment, the core adhesive layer is from 25-50 μm. In still another embodiment, the skin adhesive layers are each 25-50 μm. In many embodiments, a multiple layer tape is produced using a PET carrier having a thickness of 2.4 μm to 12.5 μm. The overall or total thickness of the tape is from 50 μm to 300 μm. However, it will be appreciated that the present subject matter includes the use of adhesive coatweights, polymeric film thicknesses, and overall thicknesses less than and/or greater than these values.

The layered assembly can also consist of multiple adhesive layers. In a particular embodiment, the layered assembly consists of a core adhesive layer which contains expanding microspheres and two bordering skin layers. In a particular embodiment, the adhesive component of the adhesive layers of the layered assembly is rubber-based.

Many of the layered assemblies of the present subject matter comprise a release liner or layer that covers an otherwise exposed face of any of the adhesive layer or layers. Typically, the release liner includes a layer of a silicone release agent that contacts the adhesive layer. A wide array of release liners can be used in the layered assemblies of the present subject matter. Commercially available release liners can be used such as those from Mitsubishi.

The articles of the present subject matter in certain embodiments, include one, two, or more polymeric films or substrate layers in addition to one, two, or more layers of the adhesive formulation. In certain embodiments, the layered assemblies include one polymeric film, with one or two layers of the adhesive formulation. In other embodiments, the layered assemblies include two polymeric films or substrate layers in combination with one or two layers of the adhesive formulation. The present subject matter also comprises other layered assemblies or articles having a number of layers less than or greater than these arrangements.

The layered assemblies or articles are formed by deposition or coating of the adhesive formulation on one or more films or substrate layers followed by expansion of the microspheres as described herein. Nonlimiting examples of coating methods include slot die, air knife, brush, curtain, extrusion, blade, floating knife, gravure, kiss roll, knife-over-blanket, knife-over-roll, offset gravure, reverse roll, reverse-smoothing roll, rod, and squeeze roll coating. The present subject matter also includes at least partially expanding the microspheres dispersed in the adhesive formulation prior to and/or during deposition of the adhesive formulation.

For the embodiments consisting solely of adhesive layers, each of the adhesive layers are coated on a release liner and then laminated together to make the final construction. The final construction is comprised of a central adhesive core layer and two adhesive skin layers, on each side of the adhesive core.

In many embodiments of the present subject matter, prior to, during, or after expansion of the microspheres; the adhesive formulation is at least partially cured. Typically, curing or at least partial curing is performed or at least promoted by heating. However, the present subject matter also includes curing performed by exposure to radiant energy such as UV light and/or electron beam. In a particular embodiment of the current invention, the construction is cross-linked by electron beam at 1-10 megarad (Mrd) radiation dose.

As previously noted, after expansion of the microspheres, the microspheres significantly increase in size. Since the microspheres are in many embodiments of the present subject matter, dispersed throughout the adhesive matrix, the resulting adhesive formulation also increases in volume. It will be understood that expansion of the adhesive formulations in accordance with the present subject matter occurs as a result of expansion of discrete polymeric particles having gas-filled cores. This is distinguishable from conventional foaming techniques in which expansion of pockets of gas in a polymeric composition occurs.

As previously noted, expansion of the adhesive formulation can occur prior to, during, or after application or deposition of the adhesive formulation onto a film or layer of interest. In many embodiments, expansion occurs after deposition or coating of the adhesive formulation onto a film or layer.

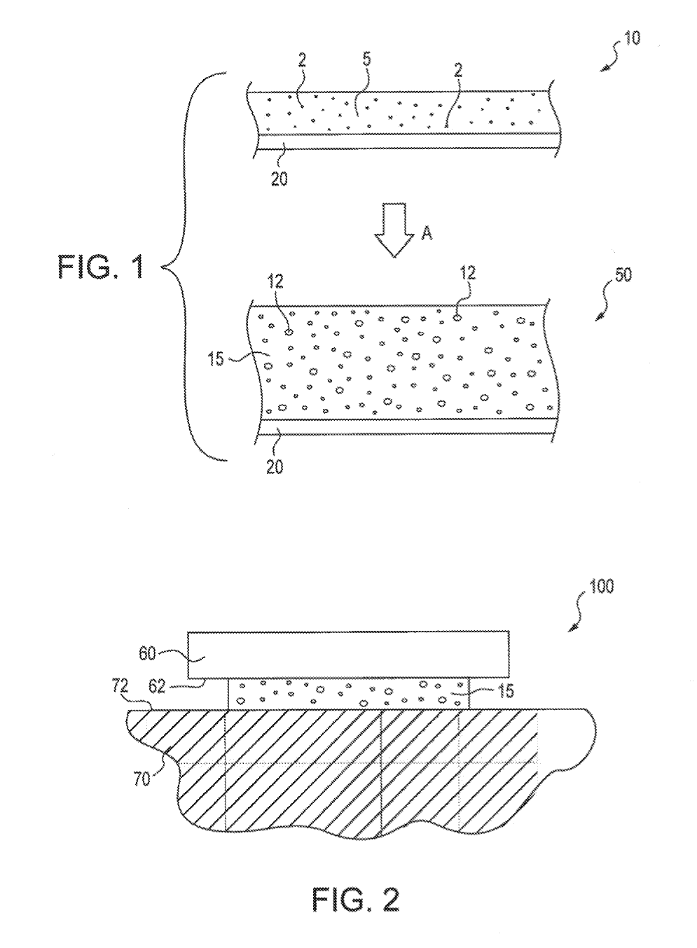

FIG. 1 schematically illustrates a layered assembly prior to expansion designated as 10, and the layered assembly after expansion designated as 50, in accordance with the present subject matter. The layered assembly 10, 50 comprises a polymeric film 20 such as for example PET, having a layer of an adhesive disposed thereon. Prior to expansion, the adhesive layer includes a plurality of expandable microspheres 2 dispersed within an adhesive matrix 5. After expansion, denoted by arrow A, the volume of the adhesive layer significantly increases. The volume increase, in many applications, is reflected in a significant increase in the thickness of the adhesive layer. After expansion, the adhesive layer includes a plurality of expanded microspheres 12 dispersed throughout the adhesive matrix, now designated as 15 due to the volume increase.

FIG. 2 schematically illustrates an application or use of the present subject matter adhesive. Specifically, a layer or region of the expanded adhesive 15 is disposed between a substrate 70 and a component 60 to be attached or adhered thereto. The layer of adhesive 15 can be provided on a film or carrier layer, applied to the substrate 70, and the film or carrier layer removed. Specifically, the layer of adhesive 15 is in contact with a surface 72 of the substrate 70 and a surface 62 of the component 60 to thereby adhesively bond the component 60 to the substrate 70. As described in greater detail herein, expanded adhesive regions or layers exhibit excellent shock or impact absorbing characteristics. The expanded adhesive regions or layers also exhibit excellent vibration damping properties. Thus, if a substrate such as 70 is subjected to vibration, shocks, or other impacts, use of the adhesive 15 disposed between the substrate 70 and the component 60 absorbs a significant portion of the vibration, shock or impact and thus reduces the extent of such which is transferred or transmitted to the component 60.

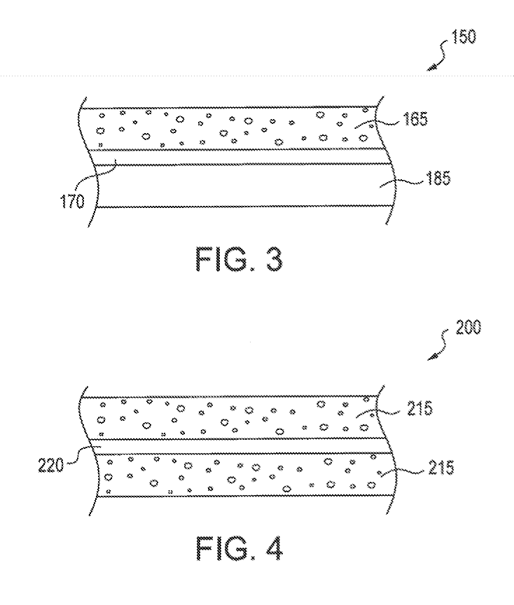

FIG. 3 schematically illustrates another layered assembly 150 in accordance with the present subject matter. The assembly 150 comprises a polymeric film or material 170 and a first layer of adhesive 165 disposed along one face of the film, and a second layer of adhesive 185 disposed along another oppositely directed face of the film. In this particular embodiment, the compositions of the adhesive layers 165 and 185 are different from each other. One of the adhesive layers such as layer 165 comprises microspheres. The microspheres can be unexpanded or expanded.

FIG. 4 schematically illustrates another layered assembly 200 in accordance with the present subject matter. The assembly 200 comprises a polymeric film or material and two layers of adhesive 215, each layer disposed on an oppositely directed face of the film 220.

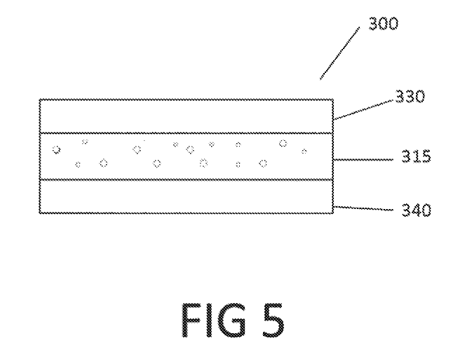

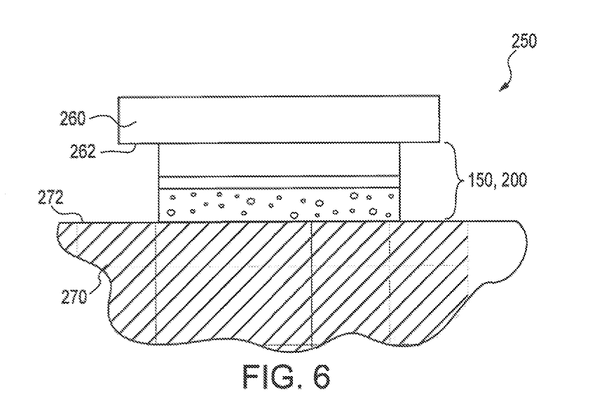

FIG. 5 schematically illustrates another layered assembly 300 in accordance with the present subject matter. The assembly 300 comprises a core foamed adhesive layer 315 and first skin layer 330 and second skin layer 340. Each skin layer is directly adjacent the foamed adhesive layer 315.

FIG. 6 schematically illustrates an adhesively bonded assembly 250 comprising a layered adhesive assembly 150 or 200, disposed between and adhesively bonding a component 260 to a substrate 270 for example. Specifically, one adhesive face of the layered assembly 150, 200 is in contact with a face 262 of the component 260; and another adhesive face of the layered assembly 150, 200 is in contact with a face 272 of the substrate 270.

The layered assembly of FIG. 5 can be also be similarly used as the embodiment shown in FIG. 6. The first skin layer 330 would attach to a component (such as 260 of FIG. 6) and the second skin layer 340 would attach to the substrate 270.

### Methods

The present subject matter also provides methods of absorbing mechanical shocks, impacts, and/or vibration to a component that is affixed, or which is to be affixed, to a substrate or other mounting surface. Generally, the methods comprise providing a layer or region of the adhesive formulation described herein containing expandable microspheres, and disposing the layer between the component and the substrate. Upon expansion of the adhesive, the resulting layer of expanded adhesive absorbs mechanical shocks or impacts, and/or dampens vibration otherwise transmitted to the component of interest. In embodiments that include a core adhesive layer and a first and second skin adhesive layer, the skin layers each attach to one of the component and substrate. The core layer is disposed between the first and second skin layer. The first skin layer attaches to the component and the second skin layer attaches to the substrate.

The present subject matter will find wide application in a variety of different fields and uses. A nonlimiting example is as a shock absorbing adhesive for attaching glass or display panels to mounting substrates of electronic devices, and in particular to mobile electronic devices such as tablet computers, laptop computers, and smartphones.

### EXAMPLES

A series of investigations were undertaken to assess characteristics and properties of the adhesive formulations.

### Example 1

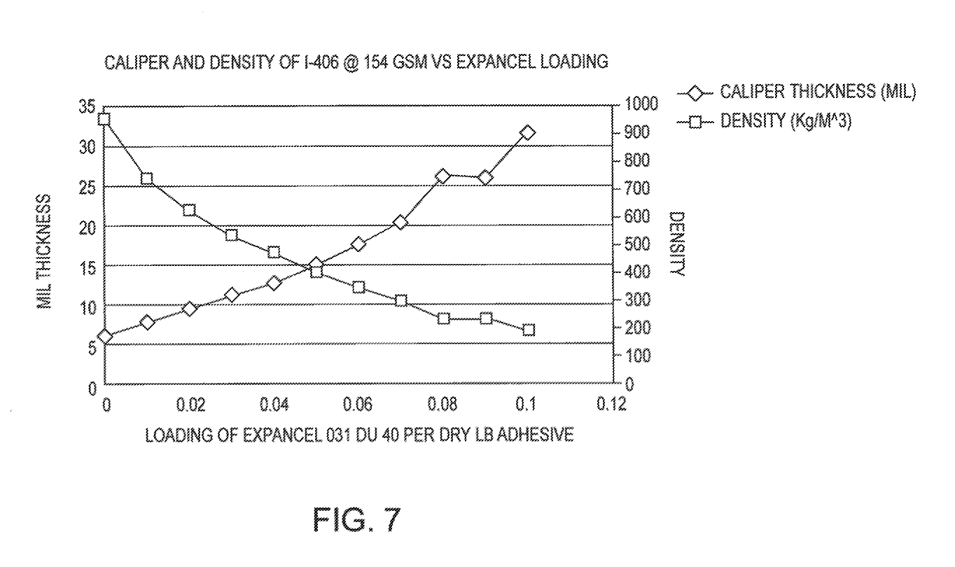

Samples were prepared of an adhesive formulation containing varying amounts of 40 micron microspheres dispersed in a rubber adhesive commercially available from Avery Dennison under the designation 1-406. The adhesive formulation in all samples was coated on the film at a coatweight of 154 grams per square meter (gsm). After coating and formation of a layer of the adhesive, microsphere expansion was performed by heating. The higher the concentration or loading of the microspheres in the expanded adhesive, the thicker the adhesive layer. Also, the higher the concentration or loading of the microspheres in the expanded adhesive, the lower the density of the resulting expanded adhesive layer. FIG. 7 is a graph illustrating these relationships.

Additional samples were also prepared to evaluate adhesive characteristics of the adhesive formulations such as peel adhesion and loop tack. In these evaluations, the adhesive formulations comprised an adhesive matrix including an SIS rubber adhesive, varying amounts of 40 micron microspheres, and varying amounts of carbon black. After formation of the layered assembly samples and expansion of the adhesive, the adhesive samples were subjected to stainless steel (SS) peel adhesion, polypropylene (PP) peel adhesion, and loop tack evaluation.

Peel adhesion is the average force to remove an adhesive laminated under specified conditions on a substrate, from the substrate at constant speed and at a specified angle, usually 90° or 180°. Peel adhesion evaluation was performed according to a modified version of the standard tape method Pressure Sensitive Tape Council, PSTC-2 (rev. 1995), Peel Adhesion for Single Coated Tapes, where the peel angle is 90°, at a rate of 50 cm/min (20 in/min).

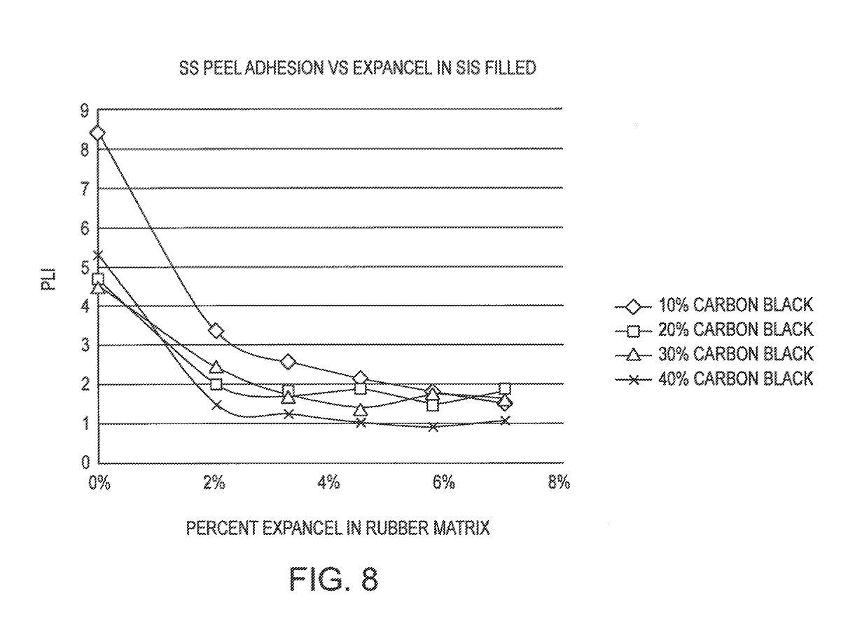

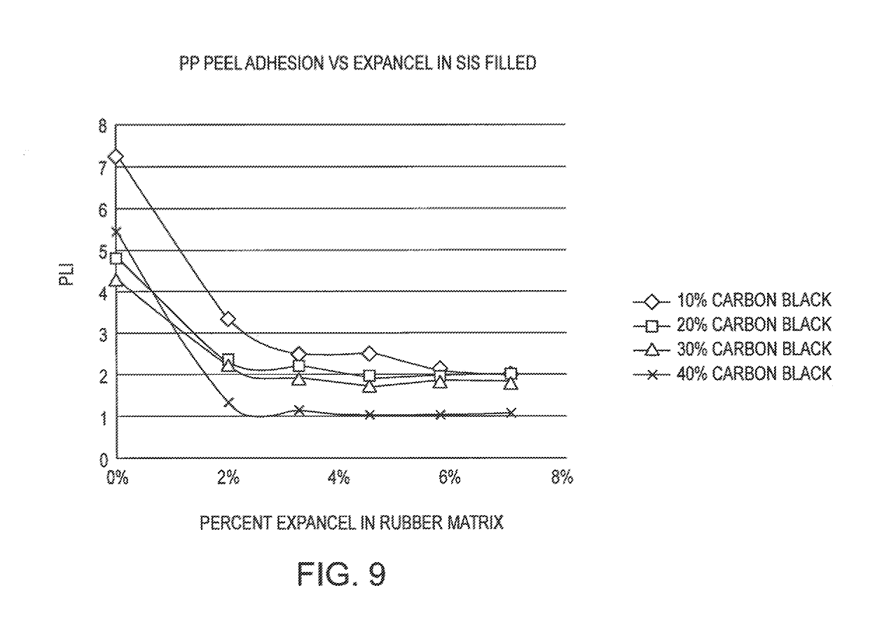

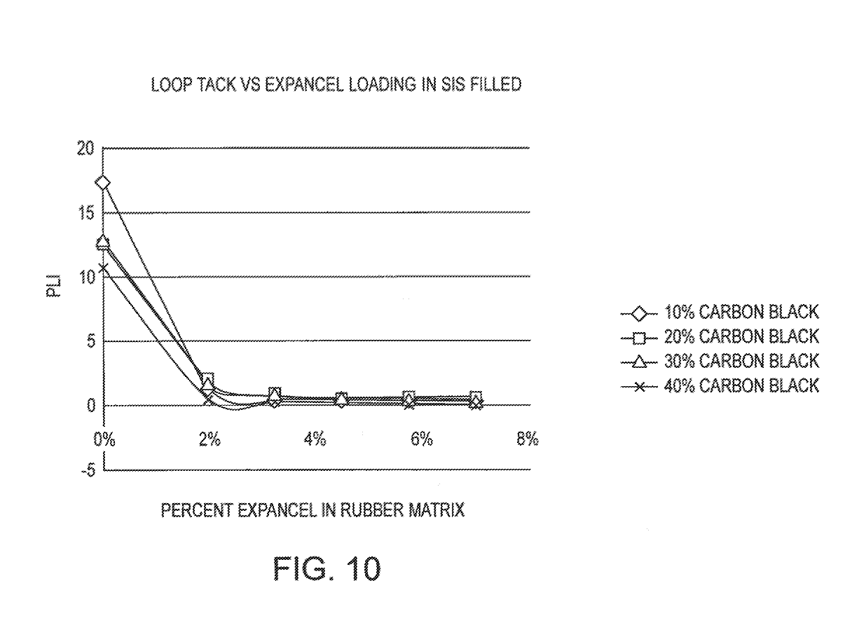

Loop tack measurements are made for strips that are about 25 mm (1 inch) wide using stainless steel as the substrate at a draw rate of about 50 cm/min (20 in/min), according to standard test 1994 Tag and Label Manufacturers Institute, Inc. (TLMI) Loop Tack Test L-1B2, using an Instron Universal Testor Model 4501 from Instron (Canton, Mass.). Loop tack values are taken to be the highest measured adhesion value observed during the test. Generally, peel adhesion and loop tack values decreased as the amount of microspheres increased. FIGS. 8-10 graphically illustrate the results of these investigations.

For many applications, expanded adhesive layered assemblies or adhesive articles of the present subject matter provide an adhesive strength of at least 1 pound per inch, in certain embodiments at least 2 pounds per inch, and particularly at least 3 pounds per inch. These adhesive strength values are with regard to a 90 degree tensile measurement. It will be appreciated that the present subject matter includes the use of expanded adhesive layers having characteristics or properties different than these.

As previously noted many of the expanded adhesive layered assemblies or adhesive articles exhibit excellent shock or impact absorbing characteristics. In many embodiments, the greater the amount of microspheres in the adhesive formulation, the greater the ability to absorb shocks or impacts.

Depending upon the adhesive formulation, the adhesive characteristics can increase or decrease over time. In many embodiments, the adhesive is tacky and is a pressure sensitive adhesive. The present subject matter includes the use of a two stage adhesive that utilizes a trigger temperature or other stimulus.

### Example 2

In another series of investigations, layered assemblies using an expanded adhesive formulation adhesively bonded to a stainless steel panel were drop tested to evaluate the shock absorbing characteristics of the expanded adhesive. Specifically, 5 samples were prepared, each at 3% loading of microspheres per dry using modified acrylic adhesive material, and subjected to 10 drops per minute for a total of 500 drops. Details of the drop testing procedure are as follows. Table 4 summarizes the results of the drop tests.

TABLE 4
Results of Drop Testing

| | After 100 | After 200 | After 300 | After 400 | After 500 |
|---|---|---|---|---|---|
| Sample | drops | drops | drops | drops | drops |
| 1 | Pass | Pass | Pass | Pass | Pass |
| 2 | Pass | Pass | Pass | Pass | Pass |
| 3 | Pass | Fail | Fail | Fail | Fail |
| 4 | Pass | Pass | Pass | Pass | Pass |
| 5 | Pass | Pass | Pass | Pass | Pass |

All samples passed 500 drops except for Sample 3. The reason for failure in sample 3 was due to deformation of the stainless steel panel.

### Example 3

In another series of evaluations, various layered assemblies using an expanded adhesive formulation were prepared and evaluated. The adhesive formulation used in the samples included a modified acrylic adhesive, toluene, and 40 micron microspheres as set forth below in Table 5.

TABLE 5
Adhesive Formulations

| Description | Amount (lbs) | % Wet | % Dry |
|---|---|---|---|
| Modified Acrylic Adhesive | 66.14 | 85% | 97% |
| Toluene | 10.65 | 14% | |
| 40 micron microspheres | 1.07 | 1% | 3% |

Samples 1-6 were prepared, several using a carrier and several without a carrier as set forth in Table 6.

TABLE 6
Samples 1-6 of Example 3

| | Adhesive 1 | | Adhesive 2 | Total Caliper |
|---|---|---|---|---|
| Sample | Coat Weight | Carrier | Coat Weight | (um) |
| 1 | 30 GSM | None | 0 | 50 |
| 2 | 50 GSM | None | 0 | 90 |
| 3 | 75 GSM | None | 0 | 135 |
| 4 | 30 GSM | 4.5 um Carrier | 30 | 140 |
| 5 | 50 GSM | 4.5 um Carrier | 50 | 200 |
| 6 | 75 GSM | 4.5 um Carrier | 75 | 375 |

The samples were then subjected to 90 degree peel adhesion tests using substrates of stainless steel, ABS, and polypropylene. The peel adhesion tests were performed as previously described but using a crosshead (pull) speed of 12 inches per minute and a sample size of 1 inch by 8 inches. Prior to testing, samples were subjected to either a 15 minute dwell or a 24 hour dwell period. Tables 7-18 summarize the results of these tests for stainless steel substrates. Comparative samples 1-3 were obtained corresponding to commercially available Acrylic Foam Bond AFB™ tapes from Avery Dennison Corporation. The tapes were AFB 6640, 6464, and 6625. The comparative samples were subjected to the same 90 degree peel adhesion. Tables 18-23 summarize the results of these tests for stainless steel substrates.

TABLE 7
Results of 90° Peel, Stainless Steel, Sample 1
15 Minute Dwell

| | | Average Load | Peak Load |
|---|---|---|---|
| Sample | Failure Mode | (lbf/in) | (lbf) |
| 1 | Delamination | 1.812 | 2.181 |
| 1 | Delamination | 1.814 | 1.992 |
| 1 | Delamination | 1.791 | 2.05 |
| Average | | 1.81 | 2.07 |
| Standard Deviation | | 0.01 | 0.10 |

TABLE 8
Results of 90° Peel, Stainless Steel, Sample 1
24 Hour Dwell

| | | Average Load | Peak Load |
|---|---|---|---|
| Sample | Failure Mode | (lbf/in) | (lbf) |
| 1 | Adhesive Split | 1.845 | 2.014 |
| 1 | Adhesive Split | 1.947 | 2.143 |
| 1 | Adhesive Split | 2.017 | 2.182 |
| Average | | 1.94 | 2.11 |
| Standard Deviation | | 0.09 | 0.09 |

TABLE 9
Results of 90° Peel, Stainless Steel, Sample 2
15 Minute Dwell

| | | Average Load | Peak Load |
|---|---|---|---|
| Sample | Failure Mode | (lbf/in) | (lbf) |
| 2 | Delamination | 1.555 | 1.755 |
| 2 | Delamination | 1.559 | 1.732 |
| 2 | Delamination | 1.51 | 1.674 |
| Average | | 1.54 | 1.72 |
| Standard Deviation | | 0.03 | 0.04 |

TABLE 10
Results of 90° Peel, Stainless Steel, Sample 2
24 Hour Dwell

| | | Average Load | Peak Load |
|---|---|---|---|
| Sample | Failure Mode | (lbf/in) | (lbf) |
| 2 | Adhesive Split | 1.698 | 1.942 |
| 2 | Delamination | 1.676 | 1.84 |
| 2 | Delamination | 1.775 | 1.95 |
| Average | | 1.72 | 1.91 |
| Standard Deviation | | 0.05 | 0.06 |

TABLE 11
Results of 90° Peel, Stainless Steel, Sample 3
15 Minute Dwell

| | | Average Load | Peak Load |
|---|---|---|---|
| Sample | Failure Mode | (lbf/in) | (lbf) |
| 3 | Adhesive Split | 3.989 | 4.64 |
| 3 | Adhesive Split | 3.959 | 4.324 |
| 3 | Adhesive Split | 3.235 | 4.058 |
| Average | | 3.73 | 4.34 |
| Standard Deviation | | 0.43 | 0.29 |

TABLE 12
Results of 90° Peel, Stainless Steel, Sample 3
24 Hour Dwell

| | | Average Load | Peak Load |
|---|---|---|---|
| Sample | Failure Mode | (lbf/in) | (lbf) |
| 3 | Adhesive Split | 3.391 | 3.795 |
| 3 | Adhesive Split | 3.425 | 3.785 |
| 3 | Adhesive Split | 3.506 | 3.803 |
| Average | | 3.44 | 3.79 |
| Standard Deviation | | 0.06 | 0.01 |

TABLE 13
Results of 90° Peel, Stainless Steel, Sample 4
15 Minute Dwell

| | | Average Load | Peak Load |
|---|---|---|---|
| Sample | Failure Mode | (lbf/in) | (lbf) |
| 4 | Adhesive Split | 2.159 | 2.33 |
| 4 | Adhesive Split | 2.166 | 2.312 |
| 4 | Adhesive Split | 2.138 | 2.329 |
| Average | | 2.15 | 2.32 |
| Standard Deviation | | 0.01 | 0.01 |

TABLE 14
Results of 90° Peel, Stainless Steel, Sample 4
24 Hour Dwell

| | | Average Load | Peak Load |
|---|---|---|---|
| Sample | Failure Mode | (lbf/in) | (lbf) |
| 4 | Adhesive Split | 2.178 | 2.357 |
| 4 | Adhesive Split | 2.18 | 2.314 |
| 4 | Adhesive Split | 2.114 | 2.262 |
| Average | | 2.16 | 2.31 |
| Standard Deviation | | 0.04 | 0.05 |

TABLE 15
Results of 90° Peel, Stainless Steel, Sample 5
15 Minute Dwell

| | | Average Load | Peak Load |
|---|---|---|---|
| Sample | Failure Mode | (lbf/in) | (lbf) |
| 5 | Adhesive Split | 3.215 | 3.624 |
| 5 | Adhesive Split | 3.349 | 3.635 |
| 5 | Adhesive Split | 3.353 | 3.568 |
| Average | | 3.31 | 3.61 |
| Standard Deviation | | 0.08 | 0.04 |

TABLE 16
Results of 90° Peel, Stainless Steel, Sample 5
24 Hour Dwell

| | | Average Load | Peak Load |
|---|---|---|---|
| Sample | Failure Mode | (lbf/in) | (lbf) |
| 5 | Adhesive Split | 3.091 | 3.279 |
| 5 | Adhesive Split | 3.095 | 3.287 |
| 5 | Adhesive Split | 3.104 | 3.266 |
| Average | | 3.10 | 3.28 |
| Standard Deviation | | 0.01 | 0.01 |

TABLE 17
Results of 90° Peel, Stainless Steel, Sample 6
15 Minute Dwell

| | | Average Load | Peak Load |
|---|---|---|---|
| Sample | Failure Mode | (lbf/in) | (lbf) |
| 6 | Clean/Panel | 2.68 | 3.237 |
| 6 | Clean/Panel | 2.542 | 3.275 |
| 6 | Clean/Panel | 2.616 | 3.079 |
| Average | | 2.61 | 3.20 |
| Standard Deviation | | 0.07 | 0.10 |

TABLE 18
Results of 90° Peel, Stainless Steel, Sample 6
24 Hour Dwell

| | | Average Load | Peak Load |
|---|---|---|---|
| Sample | Failure Mode | (lbf/in) | (lbf) |
| 6 | Adhesive Split | 3.289 | 3.654 |
| 6 | Adhesive Split | 3.354 | 3.682 |
| 6 | Adhesive Split | 3.266 | 3.57 |
| Average | | 3.30 | 3.64 |
| Standard Deviation | | 0.05 | 0.06 |

TABLE 19
Results of 90° Peel, Stainless Steel, Comparative Sample
15 Minute Dwell

| | | Average Load | Peak Load |
|---|---|---|---|
| Sample | Failure Mode | (lbf/in) | (lbf) |
| AFB 6640 | Clean/Panel | 1.808 | 2.502 |
| AFB 6640 | Clean/Panel | 2.617 | 3.298 |
| AFB 6640 | Clean/Panel | 2.63 | 4.226 |
| Average | | 2.35 | 3.34 |
| Standard Deviation | | 0.47 | 0.86 |

TABLE 20
Results of 90° Peel, Stainless Steel, Comparative Sample
24 Hour Dwell

| | | Average Load | Peak Load |
|---|---|---|---|
| Sample | Failure Mode | (lbf/in) | (lbf) |
| AFB 6640 | Clean/Panel | 8.646 | 9.231 |
| AFB 6640 | Clean/Panel | 8.28 | 9.283 |
| AFB 6640 | Clean/Panel | 8.638 | 10.149 |
| Average | | 8.52 | 9.55 |
| Standard Deviation | | 0.21 | 0.52 |

TABLE 21
Results of 90° Peel, Stainless Steel, Comparative Sample
15 Minute Dwell

| | | Average Load | Peak Load |
|---|---|---|---|
| Sample | Failure Mode | (lbf/in) | (lbf) |
| AFB 6464 | Clean/Panel | 5.316 | 7.639 |
| AFB 6464 | Clean/Panel | 4.8 | 5.653 |
| AFB 6464 | Clean/Panel | 5.247 | 8.019 |
| Average | | 5.12 | 7.10 |
| Standard Deviation | | 0.28 | 1.27 |

TABLE 22
Results of 90° Peel, Stainless Steel, Comparative Sample
24 Hour Dwell

| | | Average | Peak |
|---|---|---|---|
| Sample | Failure Mode | Load (lbf/in) | Load (lbf) |
| AFB 6464 | Clean/Panel | 9.985 | 13.227 |
| AFB 6464 | Clean/Panel | 10.659 | 14.573 |
| AFB 6464 | Clean/Panel | 9.188 | 10.736 |
| Average | | 9.94 | 12.85 |
| Standard | | 0.74 | 1.95 |
| Deviation | | | |

TABLE 23
Results of 90° Peel, Stainless Steel, Comparative Sample
15 Minute Dwell

| | | Average | Peak |
|---|---|---|---|
| Sample | Failure Mode | Load (lbf/in) | Load (lbf) |
| AFB 6625 | Clean/Panel | 1.901 | 2.407 |
| AFB 6625 | Clean/Panel | 1.658 | 2.143 |
| AFB 6625 | Clean/Panel | 1.686 | 2.037 |
| Average | | 1.75 | 2.20 |
| Standard | | 0.13 | 0.19 |
| Deviation | | | |

TABLE 24
Results of 90° Peel, Stainless Steel, Comparative Sample
24 Hour Dwell

| | | Average | Peak |
|---|---|---|---|
| Sample | Failure Mode | Load (lbf/in) | Load (lbf) |
| AFB 6625 | Clean/Panel | 7.527 | 7.972 |
| AFB 6625 | Clean/Panel | 7.321 | 8.019 |
| AFB 6625 | Clean/Panel | 7.338 | 7.9 |
| Average | | 7.40 | 7.96 |
| Standard | | 0.11 | 0.06 |
| Deviation | | | |

Tables 25-36 summarize the results of these tests for samples 1-6 using ABS substrates. Tables 37-42 summarize the results of these tests for the noted comparative samples using ABS substrates.

TABLE 25
Results of 90° Peel, ABS, Sample 1
15 Minute Dwell

| | | Average | Peak |
|---|---|---|---|
| Sample | Failure Mode | Load (lbf/in) | Load (lbf) |
| 1 | Delamination | 1.946 | 2.138 |
| 1 | Delamination | 1.792 | 2.007 |
| 1 | Delamination | 1.951 | 2.181 |
| Average | | 1.90 | 2.11 |
| Standard | | 0.09 | 0.09 |
| Deviation | | | |

TABLE 26
Results of 90° Peel, ABS, Sample 1
24 Hour Dwell

| | | Average | Peak |
|---|---|---|---|
| Sample | Failure Mode | Load (lbf/in) | Load (lbf) |
| 1 | Delamination | 1.924 | 2.114 |
| 1 | Delamination | 1.939 | 2.143 |
| 1 | Delamination | 1.935 | 2.12 |
| Average | | 1.93 | 2.13 |
| Standard | | 0.01 | 0.02 |
| Deviation | | | |

TABLE 27
Results of 90° Peel, ABS, Sample 2
15 Minute Dwell

| | | Average | Peak |
|---|---|---|---|
| Sample | Failure Mode | Load (lbf/in) | Load (lbf) |
| 2 | Delamination | 1.632 | 1.848 |
| 2 | Delamination | 1.65 | 2.126 |
| 2 | Delamination | 1.596 | 1.843 |
| Average | | 1.63 | 1.94 |
| Standard | | 0.03 | 0.16 |
| Deviation | | | |

TABLE 28
Results of 90° Peel, ABS, Sample 2
24 Hour Dwell

| | | Average | Peak |
|---|---|---|---|
| Sample | Failure Mode | Load (lbf/in) | Load (lbf) |
| 2 | Delamination | 1.56 | 1.825 |
| 2 | Delamination | 1.607 | 1.817 |
| 2 | Delamination | 1.687 | 1.897 |
| Average | | 1.62 | 1.85 |
| Standard | | 0.06 | 0.04 |
| Deviation | | | |

TABLE 29
Results of 90° Peel, ABS, Sample 3
15 Minute Dwell

| | | Average | Peak |
|---|---|---|---|
| Sample | Failure Mode | Load (lbf/in) | Load (lbf) |
| 3 | Adhesive Split | 3.347 | 4.044 |
| 3 | Adhesive Split | 3.835 | 4.467 |
| 3 | Adhesive Split | 3.439 | 4.132 |
| Average | | 3.54 | 4.21 |
| Standard | | 0.26 | 0.22 |
| Deviation | | | |

TABLE 30
Results of 90° Peel, ABS, Sample 3
Hour Dwell

| | | Average | Peak |
|---|---|---|---|
| Sample | Failure Mode | Load (lbf/in) | Load (lbf) |
| 3 | Adhesive Split | 3.897 | 4.143 |
| 3 | Adhesive Split | 3.779 | 4.168 |
| 3 | Adhesive Split | 3.908 | 4.227 |
| Average | | 3.86 | 4.18 |
| Standard | | 0.07 | 0.04 |
| Deviation | | | |

TABLE 31
Results of 90° Peel, ABS, Sample 4
15 Minute Dwell

| | | Average | Peak |
|---|---|---|---|
| Sample | Failure Mode | Load (lbf/in) | Load (lbf) |
| 4 | Adhesive Split | 2.191 | 2.362 |
| 4 | Adhesive Split | 2.132 | 2.309 |
| 4 | Adhesive Split | 2.192 | 2.369 |
| Average | | 2.17 | 2.35 |
| Standard | | 0.03 | 0.03 |
| Deviation | | | |

TABLE 32
Results of 90° Peel, ABS, Sample 4
24 Hour Dwell

| | | Average | Peak |
|---|---|---|---|
| Sample | Failure Mode | Load (lbf/in) | Load (lbf) |
| 4 | Delamination | 2.012 | 2.406 |
| 4 | Delamination | 2.236 | 2.384 |
| 4 | Delamination | 2.245 | 2.366 |
| Average | | 2.16 | 2.39 |
| Standard | | 0.13 | 0.02 |
| Deviation | | | |

TABLE 33
Results of 90° Peel, ABS, Sample 5
15 Minute Dwell

| | | Average | Peak |
|---|---|---|---|
| Sample | Failure Mode | Load (lbf/in) | Load (lbf) |
| 5 | Adhesive Split | 3.221 | 3.592 |
| 5 | Adhesive Split | 3.214 | 3.599 |
| 5 | Adhesive Split | 3.337 | 3.7 |
| Average | | 3.26 | 3.63 |
| Standard | | 0.07 | 0.06 |
| Deviation | | | |

TABLE 34
Results of 90° Peel, ABS, Sample 5
24 Hour Dwell

| | | Average | Peak |
|---|---|---|---|
| Sample | Failure Mode | Load (lbf/in) | Load (lbf) |
| 5 | Adhesive Split | 3.314 | 3.506 |
| 5 | Adhesive Split | 3.228 | 3.649 |
| 5 | Adhesive Split | 3.291 | 3.537 |
| Average | | 3.28 | 3.56 |
| Standard | | 0.04 | 0.08 |
| Deviation | | | |

TABLE 35
Results of 90° Peel, ABS, Sample 6
15 Minute Dwell

| | | Average | Peak |
|---|---|---|---|
| Sample | Failure Mode | Load (lbf/in) | Load (lbf) |
| 6 | Clean/Panel | 2.365 | 2.721 |
| 6 | Clean/Panel | 2.393 | 2.666 |
| 6 | Clean/Panel | 2.29 | 2.682 |
| Average | | 2.35 | 2.69 |
| Standard | | 0.05 | 0.03 |
| Deviation | | | |

TABLE 36
Results of 90° Peel, ABS, Sample 6
24 Hour Dwell

| | | Average | Peak |
|---|---|---|---|
| Sample | Failure Mode | Load (lbf/in) | Load (lbf) |
| 6 | Clean/Panel | 2.827 | 3.191 |
| 6 | Clean/Panel | 2.606 | 2.91 |
| 6 | Clean/Panel | 2.369 | 2.902 |
| Average | | 2.60 | 3.00 |
| Standard | | 0.23 | 0.16 |
| Deviation | | | |

TABLE 37
Results of 90° Peel, ABS, Comparative Sample
15 Minute Dwell

| | | Average Load | |
|---|---|---|---|
| Sample | Failure Mode | (lbf/in) | Peak Load (lbf) |
| AFB 6640 | Clean/Panel | 0.352 | 0.536 |
| AFB 6640 | Clean/Panel | 0.464 | 0.712 |
| AFB 6640 | Clean/Panel | 0.397 | 0.592 |
| Average | | 0.40 | 0.61 |
| Standard Deviation | | 0.06 | 0.09 |

TABLE 38
Results of 90° Peel, ABS, Comparative Sample
24 Hour Dwell

| | | Average Load | |
|---|---|---|---|
| Sample | Failure Mode | (lbf/in) | Peak Load (lbf) |
| AFB 6640 | Clean/Panel | 1.065 | 1.642 |
| AFB 6640 | Clean/Panel | 1.072 | 1.958 |
| AFB 6640 | Clean/Panel | 0.907 | 1.401 |
| Average | | 1.01 | 1.67 |
| Standard Deviation | | 0.09 | 0.28 |

TABLE 39
Results of 90° Peel, ABS, Comparative Sample
15 Minute Dwell

| | | Average Load | |
|---|---|---|---|
| Sample | Failure Mode | (lbf/in) | Peak Load (lbf) |
| AFB 6464 | Clean/Panel | 3.855 | 4.811 |
| AFB 6464 | Clean/Panel | 4.031 | 4.943 |
| AFB 6464 | Clean/Panel | 4.044 | 5.237 |
| Average | | 3.98 | 5.00 |
| Standard Deviation | | 0.11 | 0.22 |

TABLE 40
Results of 90° Peel, ABS, Comparative Sample
24 Hour Dwell

| | | Average Load | |
|---|---|---|---|
| Sample | Failure Mode | (lbf/in) | Peak Load (lbf) |
| AFB 6464 | Clean/Panel | 7.217 | 8.546 |
| AFB 6464 | Clean/Panel | 7.788 | 8.424 |
| AFT 6464 | Clean/Panel | 7.689 | 8.448 |
| Average | | 7.56 | 8.47 |
| Standard Deviation | | 0.31 | 0.06 |

TABLE 41
Results of 90° Peel, ABS, Comparative Sample
15 Minute Dwell

| | | Average Load | |
|---|---|---|---|
| Sample | Failure Mode | (lbf/in) | Peak Load (lbf) |
| AFB 6625 | Clean/Panel | 0.482 | 0.816 |
| AFB 6625 | Clean/Panel | 0.442 | 0.628 |
| AFB 6625 | Clean/Panel | 0.449 | 0.673 |
| Average | | 0.46 | 0.71 |
| Standard Deviation | | 0.02 | 0.10 |

TABLE 42
Results of 90° Peel, ABS, Comparative Sample
24 Hour Dwell

| | | Average Load | |
|---|---|---|---|
| Sample | Failure Mode | (lbf/in) | Peak Load (lbf) |
| AFB 6625 | Clean/Panel | 1.245 | 1.911 |
| AFB 6625 | Clean/Panel | 1.227 | 2.302 |
| AFT 6625 | Clean/Panel | 1.41 | 2.038 |
| Average | | 1.29 | 2.08 |
| Standard Deviation | | 0.10 | 0.20 |

Tables 43-54 summarize the results of these tests for samples 1-6 using polypropylene (PP) substrates. Tables 55-60 summarize the results of these tests for the noted comparative samples using polypropylene (PP) substrates.

TABLE 43
Results of 90° Peel, PP, Sample 1
15 Minute Dwell

| | | Average Load | |
|---|---|---|---|
| Sample | Failure Mode | (lbf/in) | Peak Load (lbf) |
| 1 | Delamination | 2.014 | 2.256 |
| 1 | Delamination | 1.997 | 2.286 |
| 1 | Delamination | 1.966 | 2.239 |
| Average | | 1.99 | 2.26 |
| Standard Deviation | | 0.02 | 0.02 |

TABLE 44
Results of 90° Peel, PP, Sample 1
24 Hour Dwell

| | | Average Load | Peak Load |
|---|---|---|---|
| Sample | Failure Mode | (lbf/in) | (lbf) |
| 1 | 75% Adh Transfer | 2.159 | 2.344 |
| 1 | 75% Adh Transfer | 2.178 | 2.319 |
| 1 | 75% Adh Transfer | 2.187 | 2.353 |
| Average | | 2.17 | 2.34 |
| Standard Deviation | | 0.01 | 0.02 |

TABLE 45
Results of 90° Peel, PP, Sample 2
15 Minute Dwell

| | | Average Load | |
|---|---|---|---|
| Sample | Failure Mode | (lbf/in) | Peak Load (lbf) |
| 2 | Delamination | 1.745 | 1.966 |
| 2 | Delamination | 1.678 | 1.833 |
| 2 | Delamination | 1.687 | 1.889 |
| Average | | 1.70 | 1.90 |
| Standard Deviation | | 0.04 | 0.07 |

TABLE 46
Results of 90° Peel, PP, Sample 2
24 Hour Dwell

| | | Average Load | Peak Load |
|---|---|---|---|
| Sample | Failure Mode | (lbf/in) | (lbf) |
| 2 | Delamination | 1.837 | 2.152 |
| 2 | Delamination | 1.829 | 2.046 |
| 2 | Delamination | 1.785 | 1.969 |
| Average | | 1.82 | 2.06 |
| Standard Deviation | | 0.03 | 0.09 |

TABLE 47
Results of 90° Peel, PP, Sample 3
15 Minute Dwell

| | | Average Load | Peak Load |
|---|---|---|---|
| Sample | Failure Mode | (lbf/in) | (lbf) |
| 3 | Adhesive Split | 2.949 | 3.501 |
| 3 | Adhesive Split | 3.629 | 4.188 |
| 3 | Adhesive Split | 3.961 | 4.435 |
| Average | | 3.51 | 4.04 |
| Standard Deviation | | 0.52 | 0.48 |

TABLE 48
Results of 90° Peel, PP, Sample 3
24 Hour Dwell

| | | Average Load | Peak Load |
|---|---|---|---|
| Sample | Failure Mode | (lbf/in) | (lbf) |
| 3 | 50% Adh Transfer | 2.926 | 3.172 |
| 3 | 50% Adh Transfer | 2.858 | 3.212 |
| 3 | 50% Adh Transfer | 2.902 | 3.205 |
| Average | | 2.90 | 3.20 |
| Standard Deviation | | 0.03 | 0.02 |

TABLE 49
Results of 90° Peel, PP, Sample 4
15 Minute Dwell

| | | Average Load | Peak Load |
|---|---|---|---|
| Sample | Failure Mode | (lbf/in) | (lbf) |
| 4 | Delamination | 2.175 | 2.326 |
| 4 | Delamination | 2.151 | 2.409 |
| 4 | Delamination | 2.117 | 2.289 |
| Average | | 2.15 | 2.34 |
| Standard Deviation | | 0.03 | 0.06 |

TABLE 50
Results of 90° Peel, PP, Sample 4
24 Hour Dwell

| | | Average Load | Peak Load |
|---|---|---|---|
| Sample | Failure Mode | (lbf/in) | (lbf) |
| 4 | 50% Adh Transfer | 1.81 | 2.052 |
| 4 | 50% Adh Transfer | 1.885 | 2.207 |
| 4 | 50% Adh Transfer | 1.836 | 2.044 |
| Average | | 1.84 | 2.10 |
| Standard Deviation | | 0.04 | 0.09 |

TABLE 51
Results of 90° Peel, PP, Sample 5
15 Minute Dwell

| | | Average Load | Peak Load |
|---|---|---|---|
| Sample | Failure Mode | (lbf/in) | (lbf) |
| 5 | Adhesive Split | 3.233 | 3.456 |
| 5 | Adhesive Split | 3.241 | 3.487 |
| 5 | Adhesive Split | 3.298 | 3.575 |
| Average | | 3.26 | 3.51 |
| Standard Deviation | | 0.04 | 0.06 |

TABLE 52
Results of 90° Peel, PP, Sample 5
24 Hour Dwell

| | | Average Load | Peak Load |
|---|---|---|---|
| Sample | Failure Mode | (lbf/in) | (lbf) |
| 5 | Adhesive Split | 2.584 | 2.879 |
| 5 | Adhesive Split | 2.66 | 2.962 |
| 5 | Adhesive Split | 2.728 | 2.88 |
| Average | | 2.66 | 2.91 |
| Standard Deviation | | 0.07 | 0.05 |

TABLE 53
Results of 90° Peel, PP, Sample 6
15 Minute Dwell

| | | Average Load | Peak Load |
|---|---|---|---|
| Sample | Failure Mode | (lbf/in) | (lbf) |
| 6 | Clean/Panel | 2.722 | 2.996 |
| 6 | Clean/Panel | 2.217 | 2.619 |
| 6 | Clean/Panel | 2.347 | 2.682 |
| Average | | 2.43 | 2.77 |
| Standard Deviation | | 0.26 | 0.20 |

TABLE 54
Results of 90° Peel, PP, Sample 6
24 Hour Dwell

| | | Average Load | Peak Load |
|---|---|---|---|
| Sample | Failure Mode | (lbf/in) | (lbf) |
| 6 | Adhesive Split | 2.907 | 3.188 |
| 6 | Adhesive Split | 2.975 | 3.209 |
| 6 | Adhesive Split | 2.785 | 3.156 |
| Average | | 2.89 | 3.18 |
| Standard Deviation | | 0.10 | 0.03 |

TABLE 55
Results of 90° Peel, PP, Comparative Sample
15 Minute Dwell

| | | Average Load | Peak Load |
|---|---|---|---|
| Sample | Failure Mode | (lbf/in) | (lbf) |
| AFB 6640 | Clean/Panel | 0.099 | 0.274 |
| AFB 6640 | Clean/Panel | 0.094 | 0.254 |
| AFB 6640 | Clean/Panel | 0.181 | 0.262 |
| Average | | 0.12 | 0.26 |
| Standard Deviation | | 0.05 | 0.01 |

TABLE 56
Results of 90° Peel, PP, Comparative Sample
24 Hour Dwell

| | | Average Load | Peak Load |
|---|---|---|---|
| Sample | Failure Mode | (lbf/in) | (lbf) |
| AFB 6640 | Clean/Panel | 0.203 | 0.242 |
| AFB 6640 | Clean/Panel | 0.185 | 0.236 |
| AFB 6640 | Clean/Panel | 0.183 | 0.23 |
| Average | | 0.19 | 0.24 |
| Standard Deviation | | 0.01 | 0.01 |

TABLE 57
Results of 90° Peel, PP, Comparative Sample
15 Minute Dwell

| | | Average Load | Peak Load |
|---|---|---|---|
| Sample | Failure Mode | (lbf/in) | (lbf) |
| AFB 6464 | Clean/Panel | 0.592 | 0.843 |
| AFB 6464 | Clean/Panel | 0.616 | 0.899 |
| AFB 6464 | Clean/Panel | 0.618 | 0.907 |
| Average | | 0.61 | 0.88 |
| Standard Deviation | | 0.01 | 0.03 |

TABLE 58
Results of 90° Peel, PP, Comparative Sample
24 Hour Dwell

| | | Average Load | Peak Load |
|---|---|---|---|
| Sample | Failure Mode | (lbf/in) | (lbf) |
| AFB 6464 | Clean/Panel | 0.66 | 1.093 |
| AFB 6464 | Clean/Panel | 0.682 | 1.122 |
| AFT 6464 | Clean/Panel | 0.677 | 1.149 |
| Average | | 0.67 | 1.12 |
| Standard Deviation | | 0.01 | 0.03 |

TABLE 59
Results of 90° Peel, PP, Comparative Sample
15 Minute Dwell

| | | Average Load | Peak Load |
|---|---|---|---|
| Sample | Failure Mode | (lbf/in) | (lbf) |
| AFB 6625 | Clean/Panel | 0.162 | 0.203 |
| AFB 6625 | Clean/Panel | 0.12 | 0.201 |
| AFB 6625 | Clean/Panel | 0.129 | 0.186 |
| Average | | 0.14 | 0.20 |
| Standard Deviation | | 0.02 | 0.01 |

TABLE 60
Results of 90° Peel, PP, Comparative Sample
24 Hour Dwell

| | | Average Load | Peak Load |
|---|---|---|---|
| Sample | Failure Mode | (lbf/in) | (lbf) |
| AFB 6625 | Clean/Panel | 0.18 | 0.426 |
| AFB 6625 | Clean/Panel | 0.151 | 0.291 |
| AFT 6625 | Clean/Panel | 0.191 | 0.314 |
| Average | | 0.17 | 0.34 |
| Standard Deviation | | 0.02 | 0.07 |

Shear adhesion tests were performed upon Samples 1-6 and upon the noted comparative samples. Shear adhesion testing was performed by adhering a 1 inch by 1 inch sample to a stainless steel substrate and applying a 1000 g load on the sample. The time at which the sample fails resulting in the load falling is measured. Tables 61-66 present the results of Samples 1-6 and Tables 67-69 present the results for the comparative samples.

TABLE 61
Results of Shear Testing, Sample 1

| Sample | Time (minutes) | Failure Mode |
|---|---|---|
| 1 | 73 | Adhesive Split |
| 1 | 90 | Adhesive Split |
| 1 | 88 | Adhesive Split |
| Average | 83.67 | |
| Standard Deviation | 9.29 | |

TABLE 62
Results of Shear Testing, Sample 2

| Sample | Time (minutes) | Failure Mode |
|---|---|---|
| 2 | 56 | Adhesive Split |
| 2 | 63 | Adhesive Split |
| 2 | 48 | Adhesive Split |
| Average | 55.67 | |
| Standard Deviation | 7.51 | |

TABLE 63
Results of Shear Testing, Sample 3

| Sample | Time (minutes) | Failure Mode |
|---|---|---|
| 3 | 8 | Adhesive Split |
| 3 | 9 | Adhesive Split |
| 3 | 10 | Adhesive Split |
| Average | 9.00 | |
| Standard Deviation | 1.00 | |

TABLE 64
Results of Shear Testing, Sample 4

| Sample | Time (minutes) | Failure Mode |
|---|---|---|
| 4 | 106 | Adhesive Split |
| 4 | 53 | Adhesive Split |
| 4 | 65 | Adhesive Split |
| Average | 74.67 | |
| Standard Deviation | 27.79 | |

TABLE 65
Results of Shear Testing, Sample 5

| Sample | Time (minutes) | Failure Mode |
|---|---|---|
| 5 | 29 | Adhesive Split |
| 5 | 22 | Adhesive Split |
| 5 | 37 | Adhesive Split |
| Average | 29.33 | |
| Standard Deviation | 7.51 | |

TABLE 66
Results of Shear Testing, Sample 6

| Sample | Time (minutes) | Failure Mode |
|---|---|---|
| 6 | 8 | Adhesive Split |
| 6 | 6 | Adhesive Split |
| 6 | 8 | Adhesive Split |
| Average | 7.33 | |
| Standard Deviation | 1.15 | |

TABLE 67
Results of Shear Testing, Comparative Sample

| Sample | Time (minutes) | Failure Mode |
|---|---|---|
| AFB 6464 | 10000 | Still Hanging |
| AFB 6464 | 10000 | Still Hanging |
| AFB 6464 | 10000 | Still Hanging |
| Average | 10000.00 | |
| Standard Deviation | 0.00 | |

TABLE 68
Results of Shear Testing, Comparative Sample

| Sample | Time (minutes) | Failure Mode |
|---|---|---|
| AFB 6640 | 10000 | Still Hanging |
| AFB 6640 | 10000 | Still Hanging |
| AFB 6640 | 10000 | Still Hanging |
| Average | 10000.00 | |
| Standard Deviation | 0.00 | |

TABLE 69
Results of Shear Testing, Comparative Sample

| Sample | Time (minutes) | Failure Mode |
|---|---|---|
| AFB 6625 | 10000 | Still Hanging |
| AFB 6625 | 10000 | Still Hanging |
| AFB 6625 | 10000 | Still Hanging |
| Average | 10000.00 | |
| Standard Deviation | 0.00 | |

Dynamic shear adhesion tests were performed upon Samples 1-6 and upon the noted comparative samples. Dynamic shear testing was performed by adhering a 0.5 inch by 0.5 inch sample between a pair of ABS substrates and applying a dynamic load to the sample at a speed of 2 inches per minute. The force at which failure occurred was measured. Tables 70-75 present the results of Samples 1-6 and Tables 76-78 present the results of comparative samples.

TABLE 70
Results of Dynamic Shear Testing, Sample 1

| Sample | Failure Mode | Peak Load (lbf) |
|---|---|---|
| 1 | Adhesive Split | 30.581 |
| 1 | Adhesive Split | 23.534 |
| 1 | Adhesive Split | 23.697 |
| Average | | 25.94 |
| Standard Deviation | | 4.02 |

TABLE 71
Results of Dynamic Shear Testing, Sample 2

| Sample | Failure Mode | Peak Load (lbf) |
|---|---|---|
| 2 | Adhesive Split | 22.795 |
| 2 | Adhesive Split | 19.871 |
| 2 | Adhesive Split | 21.852 |
| Average | | 21.51 |
| Standard Deviation | | 1.49 |

TABLE 72
Results of Dynamic Shear Testing, Sample 3

| Sample | Failure Mode | Peak Load (lbf) |
|---|---|---|
| 3 | Adhesive Split | 11.085 |
| 3 | Adhesive Split | 11.469 |
| 3 | Adhesive Split | 9.72 |
| Average | | 10.76 |
| Standard Deviation | | 0.92 |

TABLE 73
Results of Dynamic Shear Testing, Sample 4

| Sample | Failure Mode | Peak Load (lbf) |
|---|---|---|
| 4 | Adhesive Split | 29.306 |
| 4 | Adhesive Split | 26.348 |
| 4 | Adhesive Split | 26.296 |
| Average | | 27.32 |
| Standard Deviation | | 1.72 |

TABLE 74
Results of Dynamic Shear Testing, Sample 5

| Sample | Failure Mode | Peak Load (lbf) |
|---|---|---|
| 5 | Adhesive Split | 21.199 |
| 5 | Adhesive Split | 20.586 |
| 5 | Adhesive Split | 20.856 |
| Average | | 20.88 |
| Standard Deviation | | 0.31 |

TABLE 75
Results of Dynamic Shear Testing, Sample 6

| Sample | Failure Mode | Peak Load (lbf) |
|---|---|---|
| 6 | Adhesive Split | 10.923 |
| 6 | Adhesive Split | 10.416 |
| 6 | Adhesive Split | 10.312 |
| Average | | 10.55 |
| Standard Deviation | | 0.33 |

TABLE 76
Results of Dynamic Shear Testing, Comparative Sample

| Sample | Failure Mode | Peak Load (lbf) |
|---|---|---|
| AFB 6464 | Adhesive Split | 38.467 |
| AFB 6464 | Adhesive Split | 49.366 |
| AFB 6464 | Adhesive Split | 31.285 |
| Average | | 39.71 |
| Standard Deviation | | 9.10 |

TABLE 77
Results of Dynamic Shear Testing, Comparative Sample

| Sample | Failure Mode | Peak Load (lbf) |
|---|---|---|
| AFB 6640 | Adhesive Split | 40.602 |
| AFB 6640 | Adhesive Split | 38.769 |
| AFB 6640 | Adhesive Split | 41.525 |
| Average | | 40.30 |
| Standard Deviation | | 1.40 |

TABLE 78
Results of Dynamic Shear Testing, Comparative Sample

| Sample | Failure Mode | Peak Load (lbf) |
|---|---|---|
| AFB 6625 | Adhesive Split | 34.387 |
| AFB 6625 | Adhesive Split | 43.269 |
| AFB 6625 | Adhesive Split | 42.652 |
| Average | | 40.10 |
| Standard Deviation | | 4.96 |

Tensile and elongation tests were performed using the supported Samples 4-6. Tensile and elongation tests were conducted using a previously described Instron Testor at a crosshead speed of 20 inches per minute, and a sample size of 1 inch by 4 inches. Tables 79-81 present the results of this testing.

TABLE 79
Results of Tensile and Elongation Testing, Sample 4

| | | Yield | Yield | Load @ | Ext. @ | Break | Strn @ | |
|---|---|---|---|---|---|---|---|---|
| | | Point | Tensile | Break | Break | tensile | Break | |
| Sample | Thickness (in) | (lbf) | (psi) | (lbf) | (in) | (psi) | (%) | Microns |
| 4 | 0.0048 | 2.9 | 604.167 | 4.059 | 0.633 | 845.625 | 31.65% | 121.92 |
| 4 | 0.0048 | 2.6 | 541.667 | 3.756 | 0.513 | 782.500 | 25.65% | 121.92 |
| 4 | 0.0048 | 2.8 | 583.333 | 3.886 | 0.572 | 809.583 | 28.60% | 121.92 |
| Average | 0.0048 | 2.77 | 576.39 | 3.90 | 0.57 | 812.57 | 0.29 | |
| Standard | 0.00 | 0.15 | 31.82 | 0.15 | 0.06 | 31.67 | 0.03 | |
| Deviation | | | | | | | | |

TABLE 80
Results of Tensile and Elongation Testing, Sample 5

| | | Yield | Yield | Load @ | Ext. @ | Break | Strn @ | |
|---|---|---|---|---|---|---|---|---|
| | | Point | Tensile | Break | Break | tensile | Break | |
| Sample | Thickness (in) | (lbf) | (psi) | (lbf) | (in) | (psi) | (%) | Microns |
| 5 | 0.00735 | 3.1 | 421.769 | 3.963 | 1.391 | 539.184 | 69.55% | 186.69 |
| 5 | 0.00735 | 3.1 | 421.769 | 4.109 | 1.001 | 559.048 | 50.05% | 186.69 |
| 5 | 0.00735 | 3.3 | 448.980 | 3.974 | 1.505 | 540.680 | 75.25% | 186.69 |
| Average | 0.0074 | 3.17 | 430.84 | 4.02 | 1.30 | 546.30 | 0.65 | |
| Standard | 0.00 | 0.12 | 15.71 | 0.08 | 0.26 | 11.06 | 0.13 | |
| Deviation | | | | | | | | |

TABLE 81
Results of Tensile and Elongation Testing, Sample 6

| | | Yield | Yield | Load @ | Ext. @ | Break | Strn @ | |
|---|---|---|---|---|---|---|---|---|
| | | Point | Tensile | Break | Break | tensile | Break | |
| Sample | Thickness (in) | (lbf) | (psi) | (lbf) | (in) | (psi) | (%) | Microns |
| 6 | 0.01175 | 2.9 | 246.809 | 3.862 | 0.511 | 328.681 | 25.55% | 298.45 |
| 6 | 0.01175 | 3 | 255.319 | 3.726 | 0.485 | 317.106 | 24.25% | 298.45 |
| 6 | 0.01175 | 2.9 | 246.809 | 4.118 | 0.568 | 350.468 | 28.40% | 298.45 |
| Average | 0.0118 | 2.93 | 249.65 | 3.90 | 0.52 | 332.09 | 0.26 | |
| Standard | 0.00 | 0.06 | 4.91 | 0.20 | 0.04 | 16.94 | 0.02 | |
| Deviation | | | | | | | | |

Table 82 summarizes the various testing of Example 3.

TABLE 82
Summary of Testing for Example 3: Evaluations

| | | 90° | | 90° | | 90° | | | |
|---|---|---|---|---|---|---|---|---|---|
| | 90° | Peels | 90° | Peels @ | | Peels @ | | | |
| | Peels | @ 24 | Peels | 24 | | 24 | | | |
| | Initial | Hours | Initial | Hours | 90° Peels | Hours | | Break | Dynamic |
| | SS | SS | ABS | ABS | Initial PP | PP | Shear | Tensile | Shear |
| Sample | (lbf/in) | (lbf/in) | (lbf/in) | (lbf/in) | (lbf/in) | (lbf/in) | (minutes) | (psi) | (lbf) |
| 1 | 1.81 | 1.94 | 1.90 | 1.93 | 1.99 | 2.17 | 83.67 | | 25.94 |
| 2 | 1.54 | 1.72 | 1.63 | 1.62 | 1.70 | 1.82 | 55.67 | | 21.51 |
| 3 | 3.73 | 3.44 | 3.54 | 3.86 | 3.51 | 2.90 | 9.00 | | 10.76 |
| 4 | 2.15 | 2.16 | 2.17 | 2.16 | 2.15 | 1.84 | 74.67 | 810.57 | 27.32 |
| 5 | 3.31 | 3.10 | 3.26 | 3.28 | 3.26 | 2.66 | 29.33 | 546.30 | 20.88 |
| 6 | 2.61 | 3.30 | 2.35 | 2.60 | 2.43 | 2.89 | 7.33 | 332.09 | 10.55 |
| AFB 6640 | 2.35 | 8.52 | 0.40 | 1.01 | 0.12 | 0.19 | 10000.00 | | 40.30 |
| AFB 6625 | 1.75 | 7.40 | 0.46 | 1.29 | 0.14 | 0.17 | 10000.00 | | 40.10 |
| AFB 6464 | 5.12 | 9.94 | 3.98 | 7.56 | 0.61 | 0.67 | 10000.00 | | 39.71 |

The evaluations of Example 3 illustrate the effects of increasing the proportion of expanded microspheres in an adhesive formulation. Generally, the use of lower loadings of microspheres leads to higher resistance to shear forces. In contrast, generally, the use of higher loadings of microspheres leads to lower or reduced resistance to shear forces.

### Example 4

In another series of evaluations, various layered assemblies using an expanded adhesive formulation were prepared and evaluated. The adhesive formulation used in the samples included a modified acrylic adhesive, toluene, and 20-40 micron microspheres as set forth below in Tables 83 and 84.

TABLE 83
Adhesive Formulations

| Description | Amount (lbs) | % Wet | % Dry |
|---|---|---|---|
| Modified Adhesive | 66.14 | 84.9 | 97 |
| Toluene | 10.65 | 13.7 | |
| 40 micron microspheres | 1.07 | 1.4 | 3 |

TABLE 84
Adhesive Formulations

| Description | Amount (lbs) | % Wet | % Dry |
|---|---|---|---|
| Modified Adhesive | 66.14 | 84.9 | 97 |
| Toluene | 10.65 | 13.7 | |
| 20 micron microspheres | 1.07 | 1.4 | 3 |

Samples 1-4 were prepared, two with a carrier and two without a carrier as set forth in Table 85.

TABLE 85
Samples 1-4 of Example 4

| | | Adhesive 1 | | Adhesive 2 Coat |
|---|---|---|---|---|
| Sample | Microsphere Used | Coat Weight | Carrier | Weight |
| 1 | 3% 20 μm | 100 GSM | None | |
| | microspheres | | | |
| 2 | 3% 40 μm | 100 GSM | None | |
| | microspheres | | | |
| 3 | 3% 40 μm | 100 GSM | 12.5 um | 100 GSM |
| | microspheres | | | |
| 4 | 3% 20 μm | 100 GSM | 12.5 um | 100 GSM |
| | microspheres | | | |

The samples were then subjected to 90 degree peel adhesion tests using substrates of stainless steel and ABS. The peel adhesion tests were performed as previously described in Example 3. Tables 86-93 summarize the results of these tests using stainless steel substrates.

TABLE 86
Results of 90° Peel, Stainless Steel, Sample 1
15 Minute Dwell

| Sample | Failure Mode | Average Load (lbf/in) | Peak Load (lbf) |
|---|---|---|---|
| 1 | Clean/Panel | 2.4 | 3.83 |
| 1 | Clean/Panel | 2.411 | 4.039 |
| 1 | Clean/Panel | 2.543 | 3.993 |
| Average | | 2.45 | 3.95 |
| Standard | | 0.08 | 0.11 |
| Deviation | | | |

TABLE 87
Results of 90° Peel, Stainless Steel, Sample 1
24 Hour Dwell

| Sample | Failure Mode | Average Load (lbf/in) | Peak Load (lbf) |
|---|---|---|---|
| 1 | Clean/Panel | 3.947 | 5.15 |
| 1 | Adhesive Split | 4.308 | 5.736 |
| 1 | Clean/Panel | 3.496 | 4.125 |
| Average | | 3.92 | 5.00 |
| Standard | | 0.41 | 0.82 |
| Deviation | | | |

TABLE 88
Results of 90° Peel, Stainless Steel, Sample 2
15 Minute Dwell

| Sample | Failure Mode | Average Load (lbf/in) | Peak Load (lbf) |
|---|---|---|---|
| 2 | Adhesive Split | 2.553 | 3.526 |
| 2 | Adhesive Split | 2.606 | 3.716 |
| 2 | Adhesive Split | 2.717 | 4.051 |
| Average | | 2.63 | 3.76 |
| Standard | | 0.08 | 0.27 |
| Deviation | | | |

TABLE 89
Results of 90° Peel, Stainless Steel, Sample 2
24 Hour Dwell

| Sample | Failure Mode | Average Load (lbf/in) | Peak Load (lbf) |
|---|---|---|---|
| 2 | Adhesive Split | 1.86 | 2.009 |
| 2 | Adhesive Split | 2.474 | 2.764 |
| 2 | Adhesive Split | 2.087 | 2.316 |
| Average | | 2.14 | 2.36 |
| Standard | | 0.31 | 0.38 |
| Deviation | | | |

TABLE 90
Results of 90° Peel, Stainless Steel, Sample 3
15 Minute Dwell

| Sample | Failure Mode | Average Load (lbf/in) | Peak Load (lbf) |
|---|---|---|---|
| 3 | Adhesive Split | 1.114 | 1.978 |
| 3 | Adhesive Split | 1.143 | 1.368 |
| 3 | Adhesive Split | 1.076 | 1.513 |
| Average | | 1.11 | 1.62 |
| Standard | | 0.03 | 0.32 |
| Deviation | | | |

TABLE 91
Results of 90° Peel, Stainless Steel, Sample 3
24 Hour Dwell

| Sample | Failure Mode | Average Load (lbf/in) | Peak Load (lbf) |
|---|---|---|---|
| 3 | Delamination | 1.151 | 1.495 |
| 3 | Delamination | 1.138 | 1.417 |
| 3 | Delamination | 1.173 | 1.587 |
| Average | | 1.15 | 1.50 |
| Standard | | 0.02 | 0.09 |
| Deviation | | | |

TABLE 92
Results of 90° Peel, Stainless Steel, Sample 4
15 Minute Dwell

| Sample | Failure Mode | Average Load (lbf/in) | Peak Load (lbf) |
|---|---|---|---|
| 4 | Delamination | 2.069 | 2.974 |
| 4 | Delamination | 1.968 | 2.749 |
| 4 | Delamination | 1.695 | 2.805 |
| Average | | 1.91 | 2.84 |
| Standard | | 0.19 | 0.12 |
| Deviation | | | |

TABLE 93
Results of 90° Peel, Stainless Steel, Sample 4
24 Hour Dwell

| Sample | Failure Mode | Average Load (lbf/in) | Peak Load (lbf) |
|---|---|---|---|
| 4 | Adhesive Split | 2.567 | 2.987 |
| 4 | Adhesive Split | 2.395 | 2.544 |
| 4 | Adhesive Split | 2.512 | 2.762 |
| Average | | 2.49 | 2.76 |
| Standard | | 0.09 | 0.22 |
| Deviation | | | |

Tables 94-101 summarize the results of these tests for Samples 1-4 using ABS substrates.

TABLE 94
Results of 90° Peel, ABS, Sample 1
15 Minute Dwell

| Sample | Failure Mode | Average Load (lbf/in) | Peak Load (lbf) |
|---|---|---|---|
| 1 | Clean/Panel | 2.338 | 3.998 |
| 1 | Clean/Panel | 2.568 | 3.697 |
| 1 | Clean/Panel | 2.166 | 4.248 |
| Average | | 2.36 | 3.98 |
| Standard | | 0.20 | 0.28 |
| Deviation | | | |

TABLE 95
Results of 90° Peel, ABS, Sample 1
24 Hour Dwell

| | | | Peak Load |
|---|---|---|---|
| Sample | Failure Mode | Average Load (lbf/in) | (lbf) |
| 1 | Clean/Panel | 2.414 | 3.582 |
| 1 | Clean/Panel | 2.573 | 4.042 |
| 1 | Clean/Panel | 2.543 | 3.607 |
| Average | | 2.51 | 3.74 |
| Standard Deviation | | 0.08 | 0.26 |

TABLE 96
Results of 90° Peel, ABS, Sample 2
15 Minute Dwell

| | | | Peak Load |
|---|---|---|---|
| Sample | Failure Mode | Average Load (lbf/in) | (lbf) |
| 2 | Adhesive Split | 2.412 | 2.974 |
| 2 | Adhesive Split | 2.567 | 3.721 |
| 2 | Adhesive Split | 2.626 | 3.544 |
| Average | | 2.54 | 3.41 |
| Standard Deviation | | 0.11 | 0.39 |

TABLE 97
Results of 90° Peel, ABS, Sample 2
24 Hour Dwell

| | | | Peak Load |
|---|---|---|---|
| Sample | Failure Mode | Average Load (lbf/in) | (lbf) |
| 2 | Adhesive Split | 2.038 | 2.551 |
| 2 | Adhesive Split | 1.952 | 2.496 |
| 2 | Adhesive Split | 1.905 | 2.317 |
| Average | | 1.97 | 2.45 |
| Standard Deviation | | 0.07 | 0.12 |

TABLE 98
Results of 90° Peel, ABS, Sample 3
15 Minute Dwell

| | | | Peak Load |
|---|---|---|---|
| Sample | Failure Mode | Average Load (lbf/in) | (lbf) |
| 3 | Adhesive Split | 1.011 | 1.307 |
| 3 | Delamination | 1.324 | 2.64 |
| 3 | Delamination | 1.33 | 2.602 |
| Average | | 1.22 | 2.18 |
| Standard Deviation | | 0.18 | 0.76 |

TABLE 99
Results of 90° Peel, ABS, Sample 3
24 Hour Dwell

| | | | Peak Load |
|---|---|---|---|
| Sample | Failure Mode | Average Load (lbf/in) | (lbf) |
| 3 | Adhesive Split | 1.62 | 1.895 |
| 3 | Delamination | 1.057 | 1.912 |
| 3 | Delamination | 1.205 | 1.509 |
| Average | | 1.29 | 1.77 |
| Standard Deviation | | 0.29 | 0.23 |

TABLE 100
Results of 90° Peel, ABS, Sample 4
15 Minute Dwell

| | | | Peak Load |
|---|---|---|---|
| Sample | Failure Mode | Average Load (lbf/in) | (lbf) |
| 4 | Delamination | 1.883 | 2.931 |
| 4 | Delamination | 1.863 | 2.634 |
| 4 | Delamination | 1.969 | 4.544 |
| Average | | 1.91 | 3.37 |
| Standard Deviation | | 0.06 | 1.03 |

TABLE 101
Results of 90° Peel, ABS, Sample 4
24 Hour Dwell

| | | | Peak Load |
|---|---|---|---|
| Sample | Failure Mode | Average Load (lbf/in) | (lbf) |
| 4 | Delamination | 1.814 | 2.682 |
| 4 | Delamination | 2.161 | 3.438 |
| 4 | Delamination | 1.744 | 2.337 |
| Average | | 1.91 | 2.82 |
| Standard Deviation | | 0.22 | 0.56 |

Shear adhesion tests were performed upon Samples 1-4. Shear adhesion testing was conducted as previously described in association with Example 3. Tables 102-105 present the results of testing for Samples 1-4.

TABLE 102
Results of Shear Testing, Sample 1

| Sample | Time (minutes) | Failure Mode |
|---|---|---|
| 1 | 10000 | Still Hanging |
| 1 | 10000 | Still Hanging |
| 1 | 10000 | Still Hanging |
| Average | 10000.00 | |
| Standard Deviation | 0.00 | |

TABLE 103
Results of Shear Testing, Sample 2

| Sample | Time (minutes) | Failure Mode |
|---|---|---|
| 2 | 403 | Adhesive Split |
| 2 | 376 | Adhesive Split |
| 2 | 390 | Adhesive Split |
| Average | 389.67 | |
| Standard Deviation | 13.50 | |

TABLE 104
Results of Shear Testing, Sample 3

| Sample | Time (minutes) | Failure Mode |
|---|---|---|
| 3 | 180 | Adhesive Split |
| 3 | 235 | Adhesive Split |
| 3 | 242 | Adhesive Split |
| Average | 219.00 | |
| Standard Deviation | 33.96 | |

TABLE 105
Results of Shear Testing, Sample 4

| Sample | Time (minutes) | Failure Mode |
|---|---|---|
| 4 | 5282 | Adhesive Split |
| 4 | 3715 | Adhesive Split |
| 4 | 6212 | Adhesive Split |
| Average | 5069.67 | |
| Standard Deviation | 1261.97 | |

Dynamic shear adhesion tests were performed upon Samples 1-4. These tests were conducted as previously described in association with Example 3. Tables 106-109 present the results of testing for Samples 1-4.

TABLE 106
Results of Dynamic Shear Testing, Sample 1

| Sample | Failure Mode | Peak Load (lbf) |
|---|---|---|
| 1 | Adhesive Split | 36.758 |
| 1 | Adhesive Split | 45.935 |
| 1 | Adhesive Split | 48.575 |
| Average | | 43.76 |
| Standard Deviation | | 6.20 |

TABLE 107
Results of Dynamic Shear Testing, Sample 2

| Sample | Failure Mode | Peak Load (lbf) |
|---|---|---|
| 2 | Adhesive Split | 13.418 |
| 2 | Adhesive Split | 15.467 |
| 2 | Adhesive Split | 14.945 |
| Average | | 14.61 |
| Standard Deviation | | 1.06 |

TABLE 108
Results of Dynamic Shear Testing, Sample 3

| Sample | Failure Mode | Peak Load (lbf) |
|---|---|---|
| 3 | Adhesive Split | 19.019 |
| 3 | Adhesive Split | 20.501 |
| 3 | Adhesive Split | 21.316 |
| Average | | 20.28 |
| Standard Deviation | | 1.16 |

TABLE 109
Results of Dynamic Shear Testing, Sample 4

| Sample | Failure Mode | Peak Load (lbf) |
|---|---|---|
| 4 | Adhesive Split | 35.454 |
| 4 | Adhesive Split | 44.383 |
| 4 | Adhesive Split | 45.957 |
| Average | | 41.93 |
| Standard Deviation | | 5.66 |

Tensile and elongation tests were performed using the supported Samples 3 and 4. The tests were conducted as previously described in Example 3. Tables 110 and 111 present the results of this testing.

TABLE 110
Results of Tensile and Elongation Testing, Sample 3

| | | | | Load @ | | Break | Strn @ | | | |
|---|---|---|---|---|---|---|---|---|---|---|
| | Thickness | Yield Point | Yield Tensile | Break | Ext. @ | Tensile | Break | Thickness | | Break |
| Sample | (in) | (lbf) | (psi) | (lbf) | Break (in) | (psi) | (%) | (μm) | Yield (N/cm) | (N/cm) |
| 3 | 0.008413 | 8.4 | 998.455 | 12.38 | 1.087 | 1471.532 | 54.35% | 213.6902 | 14.7 | 21.665 |
| 3 | 0.009068 | 8.5 | 937.362 | 12.328 | 1.067 | 1359.506 | 53.35% | 230.3272 | 14.875 | 21.574 |
| 3 | 0.009075 | 8.1 | 892.562 | 11.535 | 0.891 | 1271.074 | 44.55% | 230.505 | 14.175 | 20.18625 |
| Average | 0.0089 | 8.33 | 942.79 | 12.08 | 1.02 | 1367.37 | 0.51 | | 14.58333333 | 21.14175 |
| Standard | 0.00 | 0.21 | 53.15 | 0.47 | 0.11 | 100.46 | 0.05 | | | |
| Deviation | | | | | | | | | | |

TABLE 111
Results of Tensile and Elongation Testing, Sample 4

| | | | | Load @ | | Break | Strn @ | | | |
|---|---|---|---|---|---|---|---|---|---|---|
| | Thickness | Yield Point | Yield Tensile | Break | Ext. @ | Tensile | Break | Thickness | | Break |
| Sample | (in) | (lbf) | (psi) | (lbf) | Break (in) | (psi) | (%) | (μm) | Yield (N/cm) | (N/cm) |
| 4 | 0.006588 | 8.5 | 1290.225 | 12.299 | 1.062 | 1866.879 | 53.10% | 167.3352 | 14.875 | 21.52325 |
| 4 | 0.006575 | 8.4 | 1277.567 | 13.171 | 1.339 | 2003.194 | 66.95% | 167.005 | 14.7 | 23.04925 |
| 4 | 0.0063 | 8.2 | 1301.587 | 12.072 | 1.113 | 1916.190 | 55.65% | 160.02 | 14.35 | 21.126 |
| Average | 0.0065 | 8.37 | 1289.79 | 12.51 | 1.17 | 1928.75 | 0.59 | | 14.64166667 | 21.8995 |
| Standard | 0.00 | 0.15 | 12.02 | 0.58 | 0.15 | 69.02 | 0.07 | | | |
| Deviation | | | | | | | | | | |

Table 112 summarizes the results of testing of Example 4.

TABLE 112
Summary of Testing for Example 4 Evaluations

| | 90° Peels | 90° Peels @ | 90° Peels | 90° Peels @ | | | |
|---|---|---|---|---|---|---|---|
| | Initial SS | 24 Hour SS | Initial ABS | 24 Hour ABS | Shear | Dynamic | Break Tensile |
| Sample | (lbf/in) | (lbf/in) | (lbf/in) | (lbf/in) | (minutes) | Shear (lbf) | (psi) |
| 1 | 2.45 | 3.92 | 2.36 | 2.51 | 10000.00 | 43.76 | |
| 2 | 2.63 | 2.14 | 2.54 | 1.97 | 389.67 | 14.61 | |
| 3 | 1.11 | 1.15 | 1.22 | 1.29 | 219.00 | 20.28 | 1367.37 |
| 4 | 1.91 | 2.49 | 1.91 | 1.91 | 5069.67 | 41.93 | 1928.75 |

The testing results of Example 4 demonstrate that the use of smaller microspheres allows for higher adhesion values and shear due to a more uniform integration of the microspheres in the adhesive matrix due to the small particle size.

Additional testing was done on embodiments that contained multiple adhesive layers. Samples A, B, C and were prepared. Samples A, B, and C each consisted of two skin adhesive layers and a core adhesive layer containing microspheres. In each sample the adhesive component of each layer was a rubber-based adhesive component. Sample A consisted of 25 μm skin layers and 50m core layer. The core layer of sample A contained—20 micron microspheres. Sample B consisted of 25 μm skin layers and 50m core layer. The core layer of sample B contained—20 micron microspheres. Sample C consisted of 25 μm skin layers and 100 μm core layer. The core layer of sample C contained 20 micron microspheres.

180 degree peel testing (ASTM D3330) was done for stainless steel, ABS and polycarbonate for samples A, B and C. ASTM D3330 describes the standard 180 degree peel testing, it is also described in PSTC Method 101. A push-out test and modified ASTM D3763-10 were also performed on the samples A, B and C. The push-out method and impact method both use the same sample geometry/setup as the ASTM D3330. In the push out test the bottom coupon is pushed at a relatively slow speed (10 mm/min) while in the impact test the coupon is impacted at relatively fast 1.5 m/s. The modification of D3763-10 is in using this sample geometry/setup.

The results for these test is shown in table 113.

TABLE 113
Summary of Testing for Multilayered Adhesive Embodiment

| | | | | | | | | Modified ASTM D3763-10 | | |
|---|---|---|---|---|---|---|---|---|---|---|
| | 180 Degree Peel (ASTM D3330) | | | | | | | | Energy at | |
| | Stainless | | | | | | Push-out | Peak | Peak | Total |
| | Steel | | ABS | | Polycarbonate | | Push-out | Load | Load | Energy |
| | lbs/in | N/m | lbs/in | N/m | lbs/in | N/m | N/mm\hat{ }2 | N | J | J |
| A | 6.38 | 1118 | 5.44 | 953 | 5.54 | 971 | 1.07 | 758 | 0.079 | 0.156 |
| B | 7.91 | 1386 | 6.98 | 1223 | 6.99 | 1225 | 1.19 | 981 | 0.109 | 0.216 |
| C | 10.92 | 1913 | 7.88 | 1381 | 7.88 | 1381 | 1.02 | 896 | 0.104 | 0.197 |

Many other benefits will no doubt become apparent from future application and development of this technology.

All patents, published applications, standards, reference texts, and articles noted herein are hereby incorporated by reference in their entirety.

As described hereinabove, the present subject matter solves many problems associated with previous strategies, systems and/or articles. However, it will be appreciated that various changes in the details, materials and arrangements of components, which have been herein described and illustrated in order to explain the nature of the present subject matter, may be made by those skilled in the art without departing from the principle and scope of the claimed subject matter, as expressed in the appended claims.

1. An adhesive formulation comprising:
50 to 99% adhesive component;
0 to 3% crosslinker;
0 to 3% antioxidant; and
0.1 to 10% expandable microspheres dispersed throughout the formulation.

2. The adhesive formulation of claim 1 further comprising from 0.1 to 30% of at least one agent selected from the group consisting of fillers, pigments, plasticizers, flame retardants, UV stabilizers, and combinations thereof.

3. The adhesive formulation of claim 1 further comprising from 0.1 to 40% tackifier.

4. The adhesive formulation of claim 1 wherein the microspheres include thermoplastic polymeric shells encapsulating gas filled hollow interior cores.

5. The adhesive formulation of claim 1 wherein the microspheres have a size prior to expansion within a range of from 5 μm to 75 μm.

6. The adhesive formulation of claim 1 wherein the microspheres expand upon exposure to a temperature within a range of from 70° C. to 220° C.

7. The adhesive formulation claim 1 wherein the microspheres exhibit a nonrupture temperature within a range of from 120° C. to 210° C.

8. The adhesive formulation of claim 1 wherein the microspheres are in an unexpanded state.

9. The adhesive formulation of claim 1 wherein the microspheres are in an expanded state.

10. The adhesive formulation of claim 9 wherein the microspheres have a size after expansion within a range of from 10 μm to 200 μm.

11. The adhesive formulation of claim 1 comprising:
65 to 75% of the adhesive component;
25 to 35% of the tackifier;
0.1 to 1% of the crosslinker;
0.25 to 1% of the antioxidant; and
1.5 to 4% of the microspheres.

12. A layered adhesive assembly comprising:
a film; and
a layer of adhesive disposed on the film, the adhesive including 50 to 99% adhesive component, 0 to 3% crosslinker, 0 to 3% antioxidant, and 0.1 to 10% expandable microspheres dispersed throughout the formulation.

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. A method of absorbing mechanical shocks to a component affixed to a substrate, the method comprising:
providing a layer of adhesive including 50 to 99% adhesive component, 0 to 3% crosslinker, 0 to 3% antioxidant, and 0.1 to 10% expandable microspheres dispersed throughout the formulation;
disposing the layer of the adhesive between the component and the substrate.

28. (canceled)

29. (canceled)

30. (canceled)

31. A layered adhesive assembly comprising:
a first and second skin layer of adhesive,
a core layer of adhesive, the adhesive including 50 to 99% adhesive component, 0 to 5% crosslinker, 0 to 3% antioxidant, and 0.1 to 10% expandable microspheres dispersed throughout the formulation.

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)
